(19) United States
(12) Patent Application Publication
(10) Pub. No.: US 2012/0265770 A1
(43) Pub. Date: Oct. 18, 2012

(54) COMPUTER IMPLEMENTED SYSTEM AND METHOD FOR AUTOMATED JOB SEARCH, RECRUITMENT AND PLACEMENT

(75) Inventors: Rhéal Desjardins, Trois-Rivieres (CA); Stéphane Turcot, Trois-Rivieres (CA)

(73) Assignee: 9212-9733 Québec Inc., Trois-Rivières (CA)

(21) Appl. No.: 13/500,998

(22) PCT Filed: Aug. 6, 2010
(86) PCT No.: PCT/CA10/01227

§ 371 Date: Jun. 27, 2012

Related U.S. Application Data
(60) Provisional application No. 61/250,386, filed on Oct. 9, 2009.

(51) Int. Cl. G06F 17/30

(52) U.S. Cl. 707/748; 707/E17.033

(57) ABSTRACT

A computer system operation method for electronically screening job applicants for an electronic job posting which includes granting the job applicant access to an application process to the job when an eligibility score exceeds an eligibility threshold is described. Also described is a computer system operation method for facilitating online job searching which includes retrieving an audio-visual description of aspects of the job. Also described are computer readable storage media having stored thereon instructions for causing a computer to perform the computer system operation methods described above. Also described is a computer readable storage medium having stored thereon instructions for presenting a description of an electronic job posting in which the information is presented in a scrollable loop.

### FIELD OF INVENTION

The present invention relates generally to the field of computer implemented systems and methods to facilitate automated job searching, recruitment and placement via the Internet or other communication networks.

### BACKGROUND OF THE INVENTION

In recent years, the Internet has provided a platform for employers to post job positions and to solicit job applications, and for job seekers to search for available jobs and to submit applications. Since many of the job postings on the Internet are available to the public, employers may be flooded with numerous applications, including those from candidates who are under-qualified. An employer may have to review each job application in order select suitable candidates for a particular position. Accordingly, there is a need for a system that assists employers in screening applicants and helps job seekers in identifying appropriate positions to apply for.

### SUMMARY OF THE INVENTION

In an aspect of the invention, there is described a computer system operation method for electronically screening a job applicant for an electronic job posting selected from a database of job postings, the method comprising the steps of: retrieving a questionnaire associated with the electronic job posting from a database of questionnaires and displaying the questionnaire via a user interface associated with a computer, wherein the questionnaire comprises at least two polar questions, and wherein a preferred answer to each of the at least two polar questions, a weight associated with each preferred answer, and an eligibility threshold are preselected by a user other than the job applicant; receiving answers to the at least two polar questions from the job applicant via the user interface; determining an eligibility score using software, wherein the eligibility score is based on the number of answers the correspond to preferred answers and on the weight associated therewith; comparing the eligibility score with the eligibility threshold using software; and granting the job applicant access to an application process to the job via the user interface when the eligibility score exceeds the eligibility threshold.

In another aspect of the invention, there is described a computer readable storage medium having stored thereon instructions for electronically screening job applicants for an electronic job posting selected from a database of job postings, such that when the instructions are executed by a computer, the instructions cause the computer to execute the steps comprising: displaying on a user interface associated with the computer a questionnaire associated with the electronic job posting retrieved from a database of questionnaires, the questionnaire having at least two polar questions, wherein a preferred answer to each of the at least two polar questions, a weight associated with each preferred answer, and an eligibility threshold are preselected by a user other than the job applicant; receiving answers to the at least two polar questions from the job applicant via the user interface; determining an eligibility score based on the answers, wherein the eligibility score is based on the number of answers the correspond to preferred answers and on the weight associated therewith; comparing the eligibility score with the eligibility threshold; and granting the user access to an application process to the job via the user interface when the eligibility score exceeds the eligibility threshold.

In another aspect of the invention, there is described a computer system operation method for facilitating online job searching, the method comprising the steps of: receiving a job search request from a job applicant via a user interface associated with a computer, the job search request comprising at least one search criterion; conducting a search of a first database having job entries stored therein, based on the at least one search criterion; providing via the user interface a list comprising at least one job entry corresponding to the at least one search criterion, wherein each of the at least one job entry is represented by an illustrative image; receiving a request to view one of the at least one job entry upon the job applicant's selection of the illustrative image associated with said one of the at least one job entry; and retrieving a description associated with the job entry from a second database and presenting the description via the user interface, wherein the description is comprised of audio-visual data, and wherein, upon the job applicant's request, the description is one of a job description, an organization description and a geographical location description.

In another aspect of the invention, there is described a computer readable storage medium having stored thereon instructions for facilitating online job searching, such that when the instructions are executed by a computer, the instructions cause the computer to execute a number of steps comprising: receiving a job search request from a job applicant via a user interface associated with the computer, the job search request comprising at least one search criterion; conducting a search of a first database having job entries stored therein, based on the at least one search criterion; providing via a user interface a list comprising at least one electronic job entry corresponding to the at least one search criterion, wherein each of the at least one electronic job entry is represented by an illustrative image; receiving a request to view one of the at least one electronic job entry upon the job applicant's selection of the illustrative image associated with said one of the at least one electronic job entry; and retrieving a description associated with the electronic job entry from a second database and presenting the description via the user interface, wherein the description is comprised of audio-visual data, and wherein, upon the job applicant's request, the description relates to one of a job description, an organization description and a geographical location description.

In another aspect of the invention, there is described a computer readable storage medium having stored thereon instructions for presenting a description of an electronic job posting, such that when the instructions are executed by a computer, the instructions cause the computer to execute the steps comprising: displaying on a computer display at least two pictograms via a user interface, each of the at least two pictograms being capable of activation by a user, such that said activation cause retrieval and display by said computer of the said description about the electronic job posting; and presenting the at least two pictograms via said user interface in a scrollable loop containing the said pictograms; wherein the motion of the loop is controlled by user activation.

### BRIEF DESCRIPTION OF THE DRAWINGS

FIG. 1. is a diagram showing components to an exemplary computer implemented system for facilitating job searching and job posting implemented by way of an informational portal website;

FIGS. 2a, 2b, 2c, 2d, 3a and 3b are hierarchical functional block diagrams for the exemplary website of the system of FIG. 1;

FIGS. 4a and 4b are hierarchical functional block diagrams of an exemplary job seeker profile of the said system;

FIGS. 5a, 5b and 5c are hierarchical functional block diagrams of an exemplary corporate profile of the said system;

FIG. 6a is a process flow diagram of the exemplary website of the said system from a job seeker perspective;

FIG. 6b is a process flow diagram of the exemplary website of the said system from a corporate user perspective;

FIGS. 7a and 7b are process flow diagrams of an exemplary job entry page application of the said system;

FIG. 8 is a process flow diagram of an exemplary organization video page application of the said system;

FIG. 9 is a process flow diagram of an exemplary membership application of the said system;

FIG. 10 is a process flow diagram of an exemplary jobs encyclopaedia application of the said system;

FIGS. 11a and 11b show a process flow diagram of an exemplary directory of professional development program application of the said system;

FIGS. 12a, 12b, 13a and 13b are process flow diagrams of an exemplary job seeker member profile application of the said system;

FIGS. 14a to 20b are process flow diagrams of an exemplary corporate member profile application of the said system;

FIG. 21 is an exemplary screen display of a user interface of the website homepage of the said system;

FIG. 22 is an exemplary screen display of a user interface of the said job seeker profile;

FIG. 23 is an exemplary screen display of a user interface of a search-by-category option of the said system;

FIG. 24 is an exemplary screen display of a user interface of search results generated from a jobs available search option of the system.

FIG. 25 is an exemplary screen display of a user interface of a job entry page of the website of the system;

FIG. 26 is an exemplary screen display of a user interface of a jobs encyclopaedia page for a category of job identified as jobs of the present of the website of the system.

FIG. 27 is an exemplary screen display of a user interface of search results generated by a jobs encyclopaedia search by the system;

FIG. 28 is an exemplary screen display of a user interface of a directory of professional development programs page of the website of the system;

FIGS. 29 and 30 are exemplary screen displays of a user interface of a questionnaire for a job entry of the system;

FIG. 31 is an exemplary screen display of a user interface of the organization encyclopaedia page of the website of the system;

FIG. 32 is an exemplary screen display of a user interface of an organization video page of the system;

FIG. 33 is an exemplary screen display of a user interface of a job prospect page for a particular job of the system; and

FIG. 34 is an exemplary screen display of a user interface of an organization services page of the system.

### DETAILED DESCRIPTION OF THE EMBODIMENTS

The description that follows, and the embodiments described therein, are provided by way of illustration of an example, or examples, of particular embodiments of the principles of the present invention. These examples are provided for the purposes of explanation, and not limitation, of those principles and of the invention. In the description, which follows, like parts are marked throughout the specification and the drawings with the same respective reference numerals.

In an embodiment, there is a method, a system and a novel user interface for facilitating Internet users to search and apply for jobs and employers to offer and fill jobs. In the embodiment, there is an informational website and related user interface that also functions as an access portal to various software applications, including mobile applications, for registered users.

The website is accessible by any Internet user and provides information on jobs and employer organizations. Part of the information on jobs and organizations is provided by way of video clips. The website further provides a search function whereby a user may find information on particular jobs and employers. The website may provide access to an online questionnaire for each job such that a user may complete the questionnaire to determine his eligibility for the job. The user may apply for a job and request an interview for a job through the website. The website also provides information to the user on educational or training programs that would improve the user's eligibility for a particular job.

The website permits any user to register for a member account which then allows the user to access various software applications through the website. A registered user (“member”) may be a job seeker or a corporate member, which includes an employer organization, an educational institution, and a partner. A partner is an organization offering services or information not found on the website, such as human resources consulting firms, personnel outsourcing companies, or the like. Each member may create and maintain a secure personal profile that includes information about the member and may include the member's preferences and video clips selected by the member.

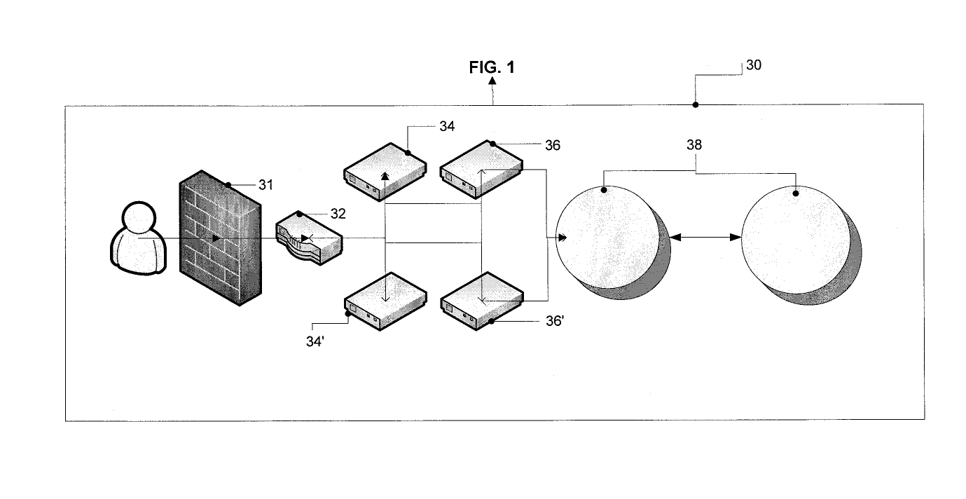

Referring to FIG. 1, the system 30 includes a firewall 31, router 32, web servers 34, 34′ operating on a computer system, and database servers 36, 36′ in two-way communication with a database 38. The use of multiple servers provides load balancing for the system 30. The framework for database 38 may be implemented in any variety of available platforms, such as .Net or Java on Oracle or Microsoft SQL Server Database, as is known to the skilled person in this art. Other database technologies may also be used, such as PHP and MySQL or Cold Fusion with Oracle. The database 38 may be made fully redundant to improve reliability of the system 30. The system 30 may operate on a 4-Tier Architecture which is expected to make the system scalable. The website software and related applications are typically stored on web servers 34, 34′ and information that is managed may be stored on database servers 36, 36′. The website software comprises computer readable program code, which when executed by a computer, will perform the various functions described hereinbelow. Those of skill in this art will be versed with producing appropriate program code in order to implement such functions according to the invention.

Data is stored in the database 38 by specific indexation, such as by jobs or organizations; by city, territory, or province; by state, country, or worldwide; or by the type of industry or sector of industries. By way of example, the indexing technology of the system may be compatible with Google™ Adds, Microsoft™ Adds, mobile technology, and all Apple™ framework and technologies (e.g. iPhone™, iPad™, Mac OS™, or the like).

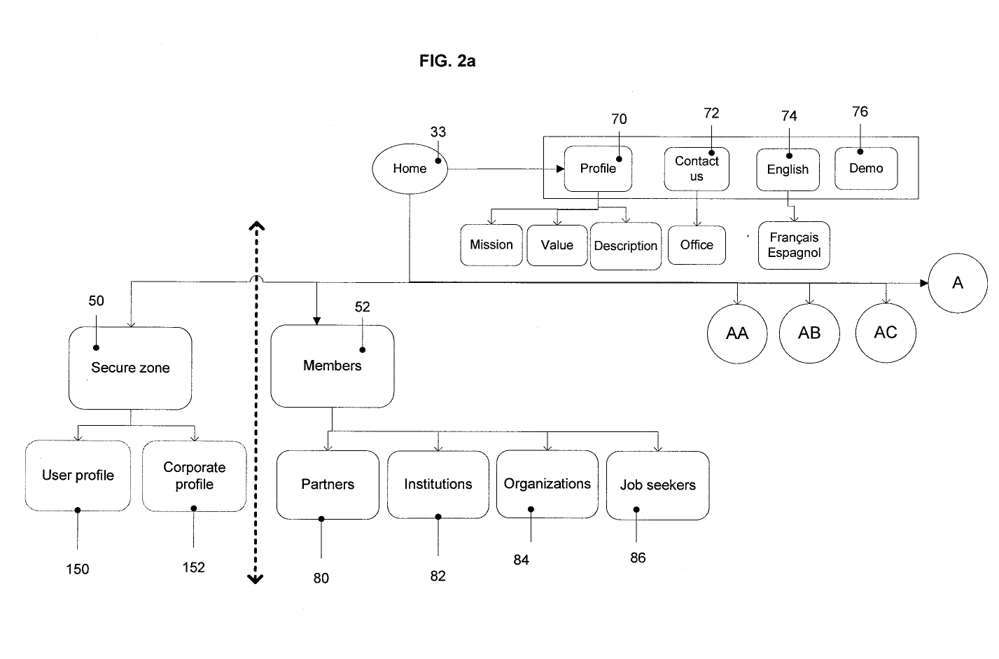

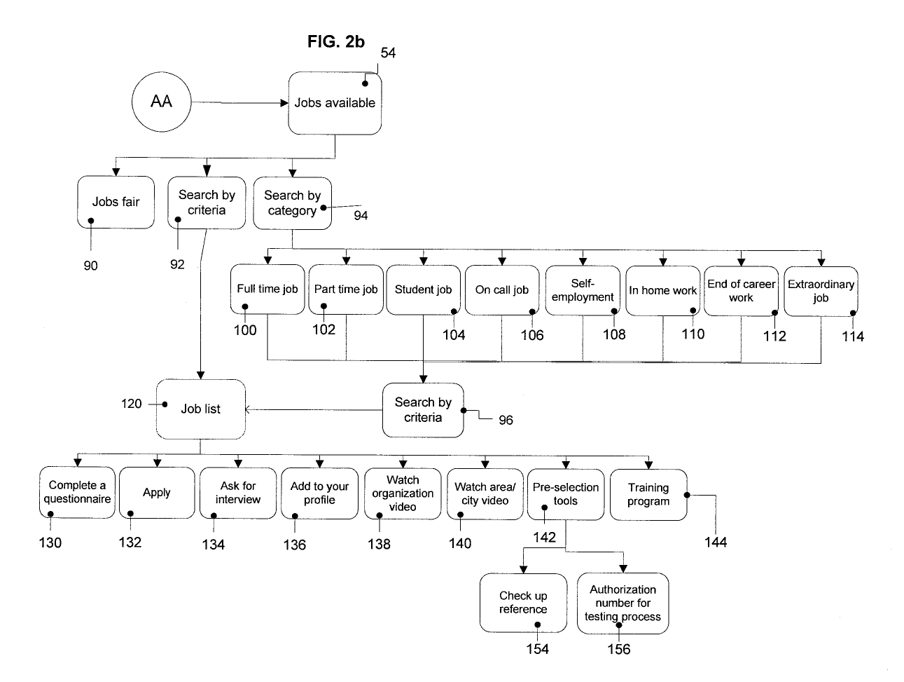

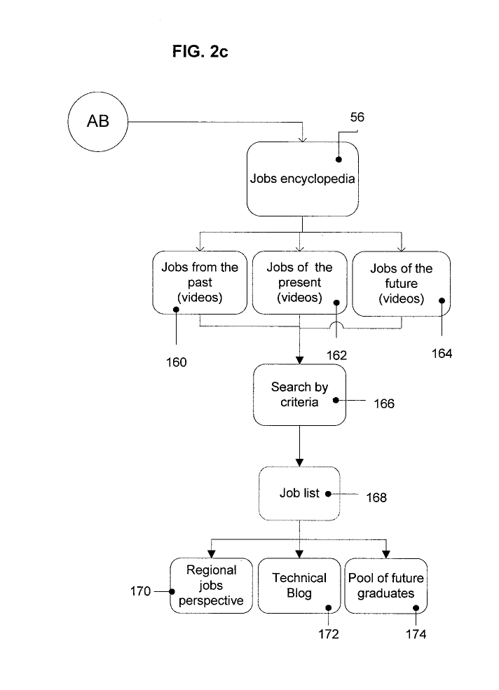

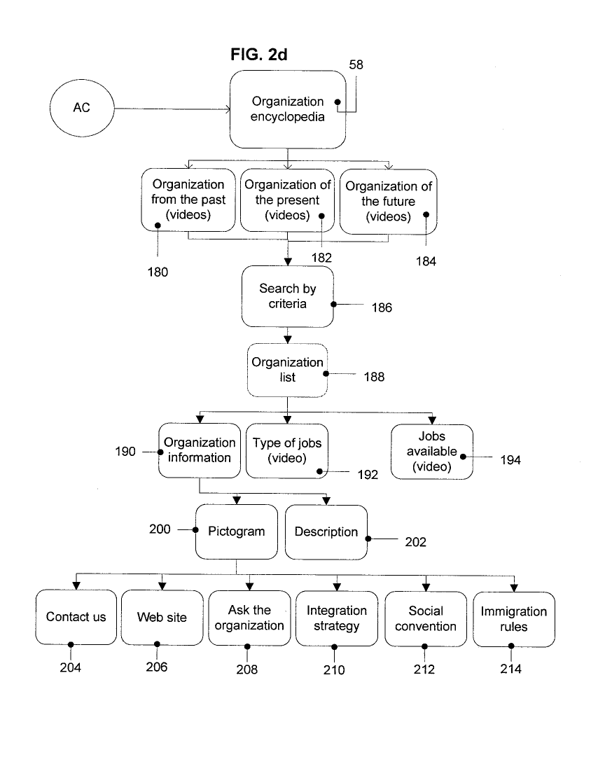

Referring to FIGS. 2 to 4, 5a, 5b and 5c, the system comprises the following segments: a website, a job seeker profile, and a corporate profile.

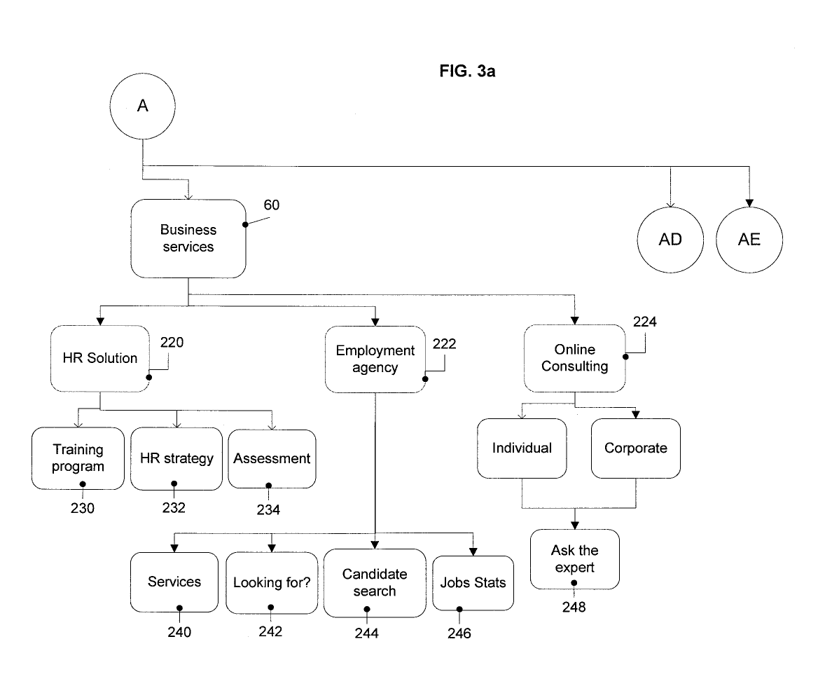

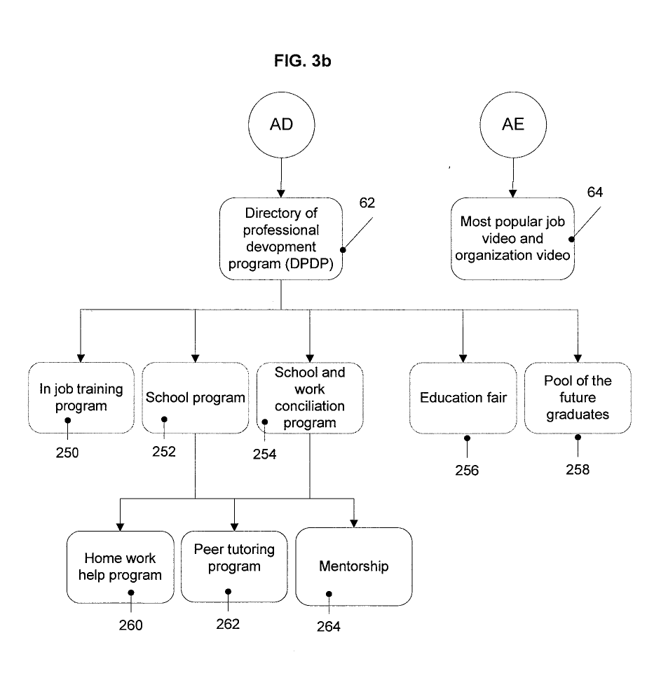

Referring to FIGS. 2a to 2d and FIGS. 3a and 3b, at the homepage 33 of the website, several options are available to the user, which include: secure zone 50; membership 52, jobs available 54, jobs encyclopaedia 56, organization encyclopaedia 58; business services 60; and directory of professional development programs 62. The user may choose to watch a video clip from the list of most popular video clips 64 displayed on the homepage. The website also allows the user to view a profile 70 of the website administrator, which may include information such as a mission statement, the values of the administrator and a description of the administrator. The contact information of the administrator is accessible to the user via the “contact us” link 72. The user may choose the language in which to view the website using the language selector 74. The website also provides the user an option 76 of viewing a demonstration of the functionalities of the website. The website may also display third party advertisement for the user's viewing.

The membership option 52 gives the user information about the categories of membership that are offered, which may include partners, educational institutions, organizations, and job seekers. After selecting the appropriate category, a user may subscribe to a member account via the website by entering information in an online form. Once a subscription is accepted by the system 30, the user is then given a unique user ID and a password (which may be user defined) that are associated with the user's member account. The system 30 offers tools (e.g. security questions) to assist members to recover user IDs and passwords. As known to those in this art, various techniques may be employed to secure the application for creating and maintaining member accounts, such as 3GES security techniques. In a 3GES approach, the software may show the user a picture comprising a combination of letters and numbers and require the user to type in the exact combination in order to access a website or an application. Each member account includes a secure personal profile 150, 152 that may only be accessed and modified by the corresponding member. A member may access his profile 150, 152 by selecting (e.g. by a mouse click, or by touch or via a touch screen) secure zone 50 and entering his user ID and password. It may also be provided for a member to access his profile 150, 152 from his mobile device, such as a personal digital assistant (PDA) or a smartphone. The profile 150 for a member who is a job seeker has functionalities that are suitable for a job seeker, such as the ability to upload a resume and save video clips of jobs of interest. The system may accept resumes of different formats, including electronic text files and video files. A corporate member, such as a partner, an institution, or an organization, would have a corporate profile 152 that provides different functionalities than a job seeker's profile. The functionalities of a job seeker profile 150 and a corporate profile 152 will be discussed in more detail hereinbelow.

The jobs available option 54 provides the user with a number of search options to search for currently available job positions, including jobs fair option 90, search by criteria option 92, or job categories option 94. By selecting the jobs fair option 90, a user may view a virtual job fair that showcases available jobs of participating organizations. The virtual job fairs may be industry-specific, city-specific, or the like. When a user selects the search by criteria option 92, the system conducts the search either using the criteria selected by the user from a preset list or by keywords entered by the user. The preset list of criteria may include geographical regions, industries, technical fields, employment categories (e.g. full-time, part-time, on-call work, self-employment, or the like), salary range, level of education required, or the like. When a user selects the search by job categories option 94, the user may choose from a number of job categories, which may include: full-time jobs 100, part-time jobs 102, jobs for students or apprenticeship positions 104, on-call work 106, self-employed work 108, work-at-home jobs 110, end of career jobs 112, and extraordinary jobs 114 (i.e. jobs that are offered to persons with physical or intellectual disabilities). After choosing a category, the user may further restrict the search results by selecting the search by criteria option 96 which operates in a similar fashion as the search by criteria option 92, described above.

The system 30 performs a search of the database 38 after the user enters some criteria under the search by criteria options 92, 96 or the user selects a category under the search by category option 94, and then the system generates and displays the search results on the website for the user's review in the form of a list of job entries 120, where each job entry is represented by an illustrative image, such as an icon or thumbnail, of a corresponding video clip of the job entry. When the user selects a job entry from the search results by selecting (e.g. by mouse click, or by touch via a touch screen) the corresponding illustrative image, the system will then redirect the user to the corresponding job entry page, where the user may watch a video clip describing the job and view information about the job, which includes a self-scrolling loop of pictograms providing supplementary information associated with the job. The pictograms are user-activated pictograms such that the information associated with each pictogram appears in a text box when the user selects the pictogram by hovering a mouse cursor over the pictogram, by touching the pictogram via a touch screen, or the like. The loop may automatically stop scrolling upon user contact, whether by mouse cursor, by touch, or the like. In another embodiment, the loop of pictograms may be stationary and may be put into scrolling motion upon user contact. In yet another embodiment, the stationary loop may be put into scrolling motion by user contact, and the direction and speed at which the loop scrolls correspond to the direction and speed of the user contact, e.g. the direction and speed of the mouse cursor or the user's touch.

Each pictogram is representative of the type of information associated with that pictogram and the information may relate to compensation structure and currency, pay raise policy, probation period, work experience and education requirements, working language, travel requirements, expense account policy, work schedule, work environment, vacation days, benefits, technology requirements, overtime policy, parental leave, dress code, training program, pension plan, childcare facilities, parking, accessibility by public transit, publication date of video clip, gross revenue of organization, size of organization, or the like. In one embodiment, the user may also select, by clicking on (using a mouse) or touching (via a touch screen), a pictogram to access a webpage containing more detailed information than what is provided in the user-activated text box.

When the user selects a job entry from the search results, the user is also provided with a number of options to select from, in addition to being presented information about the job. These options include completing a questionnaire 130, apply for the job 132, request an interview 134, add video to profile 136, watch organization video 138, watch area/city video 140, pre-selection tools 142, and training program 144.

The questionnaire option 130 allows a user to complete an online questionnaire made up of a preselected array of yes-no or true-false type questions, which are known in this art as polar questions. The questions may each carry a different weight. The weight of each question may be predetermined and subsequently adjusted by the corresponding employer organization. After the user completes the questions, the weight adjusted answers to the questionnaire are summed and, from the result, an evaluation algorithm generates an eligibility score that provides an indication of the user's eligibility for the job, when compared to an eligibility threshold percentage preset by the corresponding employer organization, as explained more fully below.

The option to complete a questionnaire 130 may be restricted to members only. A non-member may be required to submit personal information in an online form before being granted access to a questionnaire. Also, the system 30 may limit a user to retry a questionnaire, or may limit when a user may retry the questionnaire, such as by barring a retry attempt for a predetermined period of time. If the user's eligibility score is too low to be eligible for the job, the user may then be presented with information, by way of video clips, about schools and educational programs that offer the appropriate training that would likely improve the user's eligibility score. If the user's eligibility score meets the eligibility threshold set by the employer organization, then the user would be prompted and allowed access to an application process comprising several options, with the one of the options being the option to apply for the job 132.

Under the option of apply for the job 132, the user may fill out an electronic form, the format of which may be customized or preselected by the employer organization. Once the user completes the electronic form, the information provided by the user on the form is then sent to the employer organization. The format of the electronic form may conform to the specifications of the employer organization and permit the organization to develop its own database of eligible candidates.

A user whose eligibility score meets the eligibility threshold set by the employer organization and who has already applied for the job under option 132 may proceed to request an interview using the ask-for-interview option 134. This option 134 uses a synchronous communication tool that allows the eligible user to select a date and time for an interview from a schedule of available time slots provided by the organization. The interview may be conducted in person, by telephone, by video conference, or by live chat or WebConference™ over the Internet.

The user also has the option of adding a job video 136 to his profile 150, regardless of whether the user has completed the corresponding questionnaire or whether his eligibility score met the employer organization's eligibility threshold. This function 136 allows a user to maintain a personal list of jobs of interest in his profile 150. The profile application also allows the user to send job videos to others.

The user may also watch a video clip about the organization that is offering the job by selecting the watch organization video option 138. Likewise, the user may select the watch area/city video option 140 to watch a video clip about the geographical location of the job. Video clips of schools and institutions that offer training programs relating to the job are accessible to the user under the training program option 144. The user may also view video clips about the corresponding training programs under this option 144.

The pre-selection tools option 142 allows the user to complete a reference verification form 154 to provide the contact information of reference(s). The pre-selection tools option 142 also permits the user to take a test as may be required by an employer organization prior to accepting the user's request for an interview, and the user may access the test by entering an authorization code provided by the organization. The types of test may include psychological tests, technical tests, skill tests, or the like. The tests may be provided by a partner service provider, and selected and uploaded by the employer organization. The tests may be completed by the user via a web application.

From the home page 33 of the website, a user may choose the jobs encyclopaedia option 56 which allows the user to search within three categories of jobs: jobs from the past 160, jobs of the present 162, and jobs of the future 164. Jobs from the past 160 are jobs that are obsolete. Jobs of the present 162 includes all existing jobs, whether or not they are filled already. Jobs of the future 164 are further job opportunities that may be available based on information about new areas of research and emerging technologies or businesses.

After selecting one of the three categories in the jobs encyclopaedia 56, the user may further define the search by invoking searching by criteria option 166, which operates in a similar fashion as the search by criteria option 92. The search results are presented to the user in the form of a list of job entries 168, where each job entry is represented by an illustrative image. The user may select a job entry from the search results by selecting the corresponding illustrative image and the system will redirect the user to the corresponding job entry page. The job entry page allows the user to view a video clip about the job and other information about the job. For jobs of the present, the job entry page may also provide the user with a regional jobs statistical perspective option 170, which provides information on unemployment rates, trends, statistics on manpower needs, or the like, for the geographical region where the job is located. On the job entry page for a job of the present, the user may also view information about the necessary qualifications and required aptitude for the job.

There are other options available to the user on the job entry page of a job of the past, present, or future, such as the participate in a technical forum option 172 and view pool of past and future graduates option 174. The technical forum option 172 permits the user to post comments and/or questions to an online forum that is specific to the job and other users may post responses to the user's comments or questions. The ability to post comments and questions on a forum may be restricted to members only. Also, the administrator may detect the content of each technical forum and may post relevant Internet links and information to the forum. The view pool of past and future graduates option 174 provides the user information on the number of students who have successfully completed and/or who are currently enrolled in a particular educational or training program selected by the user. Such information may be provided by the participating educational institutions.

From the homepage 33, a user may choose to search the organization encyclopaedia 58. There are three categories within the organization encyclopaedia 58: organizations from the past 180, organizations of the present 182, and organizations of the future 184. Organizations from the past 180 are employer entities that no longer exist. Organizations of the present 182 are existing employer entities. Organizations of the future 184 are anticipated employers extrapolated from information and statistics on the current job market and trends. A search under each of the three categories 180, 182, 184 may be further restricted by searching by criteria 186. Under the organizations of the present category 182, the system 30 may also allow searching by images, such as company logos, using search engine technologies like Bing™ or Google™.

After an organization encyclopaedia search is conducted, the system presents the search results on the website in the form of a list of organizations 188, each represented by an illustrative image. The user may select an organization from the search results by selecting the corresponding illustrative image, in order to view a video clip about the selected organization and information about the organization 190. The user may also choose to view a list of jobs that exist within the organization 192 and jobs within the organization that are currently available 194, and a video clip of each job is available for the user's viewing. Information about an organization 190 may include: a text description of the organization 202 and a self-scrolling loop of pictograms 200, each pictogram providing supplementary information or functions relating to the organization. The pictograms are user-activated pictograms as described above, and the loop of pictogram may respond to user contact as described above. Each pictogram is representative of the type of information associated with that pictogram. In one embodiment, the user may also select, by clicking on (using a mouse) or touching (via a touch screen), a pictogram to access a webpage containing more detailed information than what is provided in the user-activated text box.

The pictograms may include organization contact information 204, organization website 206, submit questions to the organization 208, integration strategy 210, social conventions 212, and immigration rules 214. The integration strategy pictogram 210 provides information about orientation processes provided by the employer organization. The social conventions pictogram 212 provides information on the cultural and social customs of the country or region where the organization is located. The immigration rules pictogram 214 provides information on the legal and government procedures that the user would have to follow in order to work in the country or region where the organization is located.

When a user chooses the business services option 60 on the homepage, the user is provided with three options: human resource (HR) solution 220, employment agency 222, online consulting 224. Under the HR solution option 220, the user may view information about training programs 230, HR strategies 232, assessment 234. Assessment information 234 provides a catalogue of assessment and evaluation services provided by partners. If the user selects an assessment service, the system will assist the user in requesting the service from the partner, for example, by providing a link to the partner's website or the partner's email address or other contact information, or by allowing the user to send a message to the partner's profile 152. Under the employment agency option 222, the user is provided with information on employment agency services 240, looking for employment agency work 242, and job statistics 246. An employment agency may include an organization that outsources employees on a temporary basis or a headhunter-type organization. The information on looking for employment agency work 242 is a catalogue of jobs that are currently being offered by employment agencies. The user may select a job from the catalogue to proceed to apply for the job. Information on job statistics 246 provides the user with information about a job that is being offered by an employment agency, including the corresponding employer organization, salary, working hours, job duration, or the like. For any employment agency, information on job statistics 246 may also provide information identifying the employer organizations that collaborate with that particular employment agency.

Under the employment agency option 222, the user may also conduct a candidate search 244 that searches the system's database of job seeker profiles 150 for candidates with specific qualifications. The results from such a search 244 would show specific types of the information about the candidates to the user, such as level of education, work experience or other relevant qualifications, without revealing each candidate's identity to the user. The user may contact a candidate by sending a message or notification to the candidate's job seeker profile 150.

The online consulting option 224 allows a user, whether a job seeker or corporate member, to post business related questions. When a question is posted, business consultants, who may also be corporate members, will receive an electronic notification requesting the consultants to post answers to the question. The system may allow the user to contact a consultant, who provided an answer to the user's question, by email, NetMeeting™, live chat, or the like.

Under the directory of professional development programs 62, a user may view a list of educational institutions and training partners, which may be generated based on user-selected criteria, such as entity name, geographical region, training programs offered, or the like. Under this directory 62, the user may also view information about on-the-job training programs 250, school programs 252, school and work conciliation programs 254, educational fairs 256, and pool of past and future graduates 258. For school programs 252, the user may also be provided with information on homework help programs 260, peer tutoring programs 262, and mentorship programs 264. Peer tutoring program is a student-to-student tutoring program. Mentorship programs provide users with mentors who work in the relevant field. School and work conciliation programs 254 are programs that allow a student to work in a field that relates to his education or training in between or during school semesters.

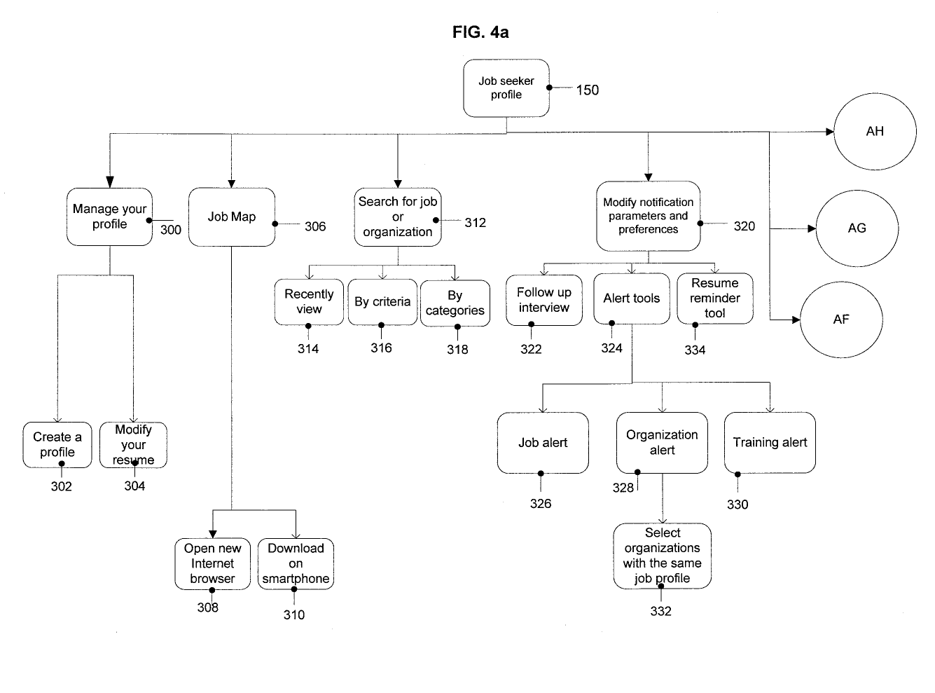

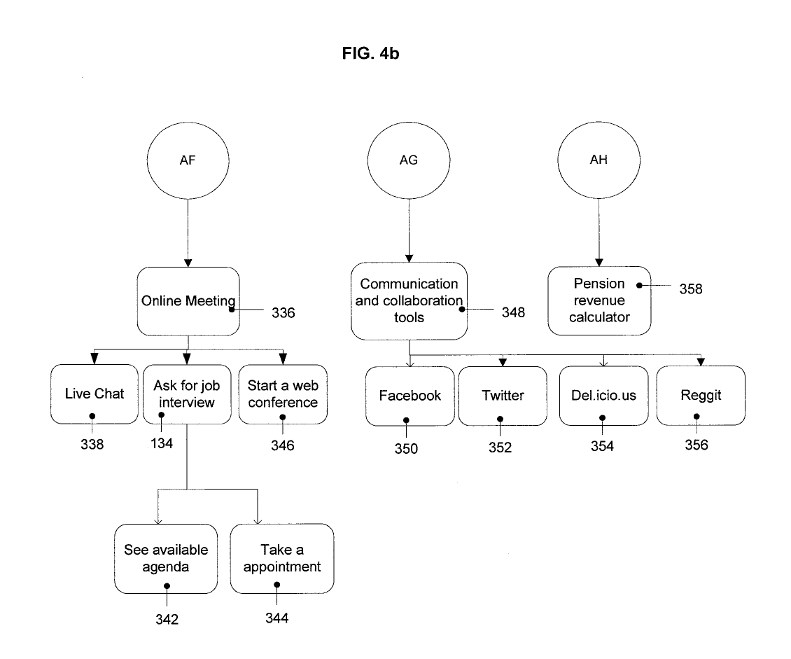

Referring to FIGS. 4a and 4b, there are hierarchical functional block diagrams of an exemplary job seeker profile 150 of the system 30. A job seeking member may access his personal profile 150 by selecting secure zone 50 on the homepage 33 and entering his user ID and password. From his personal profile 150, the member may manage his profile 300, access a job map 306, search for jobs or organizations 312, modify notification parameters and preferences 320, interact with others online 336, access other communication tools 348, and calculate pension revenue 358. The member may also save video clips of jobs and organizations that are of interest to him to his profile 150.

The manage profile option 300 allows the member to upload his resume or complete an electronic resume form detailing his education and work experience, and to modify his resume 302. Under option 300, the member may modify his job and organization preferences, and add or delete video clips of jobs and organizations from his profile. The member may also view new jobs postings that meet the member's preferences, education or work experience. Via his profile 150, the member may also sign up for a tutoring group to become a tutor for the peer tutoring program 262 or a mentor for the mentorship program 264.

The job map option 306 provides the member with a web mapping application like Google™ Maps either in a web browser 308 or downloaded to a mobile device 310. The web mapping application presents the member with a map showing the locations of available jobs within a preset area or a map of the locations of jobs that are of interest to the member, depending on the parameters set by the member and/or the information in the member's profile, such as the member's preferences. The geographical area covered by the map may be preselected by the member. For example, the member may select a specific location and a radius to generate a map displaying jobs of interest that are located within the selected distance from the specified location. For mobile devices that have positioning capabilities, such as Global Positional System, the mapping application may provide a real time map, such that the map is updated as the member's location changes (e.g. when the member is travelling in a vehicle). From his computer, the member may select a job from the map and access the corresponding job entry page to view the job video, and provided that he is eligible, as previously explained, he may also access the application process and apply for the job through the web mapping application. From his mobile device, the member may select a job from the map to view the corresponding job video clip, and he may also send the web link of the job from the mobile device to his email account or his profile for subsequent access by computer. The jobs displayed on the map may be limited to jobs entries that are in the jobs available database.

Under the search for jobs and organizations option 312, the member may search the jobs available database 54, the jobs encyclopaedia 56 and organization encyclopaedia 58, as described above. The member may also view a list of jobs that he has recently viewed 314.

In his profile 150, the member may modify his notification parameters and preferences 320 that were previously set by the member, including an interview reminder tool 322, alert tools 324, and a resume reminder tool 334. The interview reminder tool 322 provides an electronic reminder, such as an email or text message, to the member regarding an upcoming interview. The reminder is sent to the member at a predetermined time prior to the interview and the predetermined time may be set by the member. Alert tools are the member's preferences on how he is to be contacted and notified of certain events such as when a job of interest becomes available (job alert 326) or when the member becomes eligible for a job of interest. Alert tools 324 also includes an organization alert tool 328 that provides the member with a notification when an organization in his preferences list updates the organization's profile or posts a new job. Under alert tools 324, there is provided a same job profile tool 332 which allows the member, after selecting an organization, to view other organizations that have the same type of jobs as those available in the selected organization. Also available under the alert tools 324, a training alert tool 330 provides the member with a notification when changes are made to a training program listed in the member's preferences or when an institution in the member's preferences updates the institution's profile. Notification options may include SMS text message, email, electronic alert in profile 150, or the like. The resume reminder tool 334 provides the member with a notification after a preselected period of time from his last modification of his resume in his profile 150. This tool 334 provides a reminder to the member to update his resume.

The online meeting option 336 provides the member with various applications to interact with others online. The member may participate in a live chat 338 or a web conference 346 with other members, including corporate members. The online meeting option 336, therefore, allows the member to meet with personnel of employer organizations, educational institutions, and partners. If the member is eligible for a job, he may select the request an interview option 134, as described above, and then either the view available interview time slots option 342 or make an appointment for the interview option 344.

From his profile page, the member may access other communication tools 348. For example, the member may upload his preferences, video clips and other information to his account on social networking sites such as Twitter™, Facebook™, LinkedIn™, Del.icio.us™, Reggit™, or the like. Further, the member may send a video clip on a job, organization or training program to another person by email or to another member's account. The application also allows the member to install communication tools like Skype™, MSN™ Messenger, NetMeeting™, or the like. Lastly, the member's profile 150 provides the member access to a pension revenue calculator 358 that generates a pension amount from basic information provided by the member.

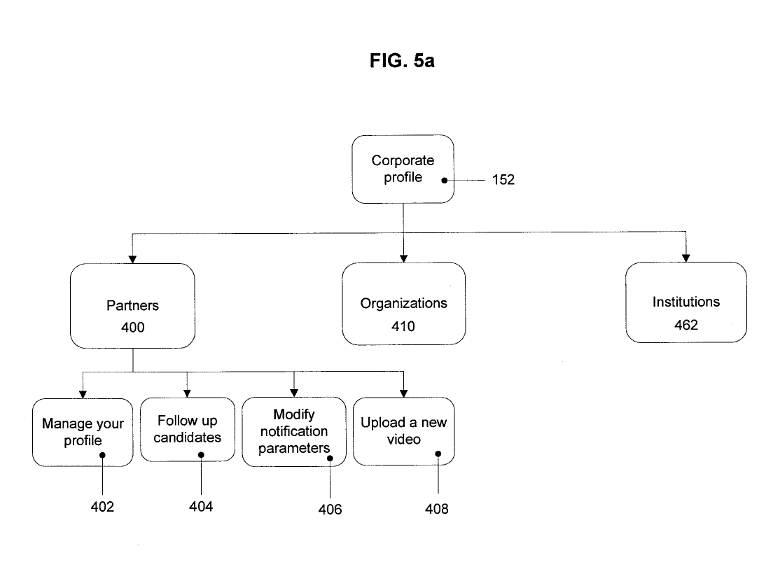

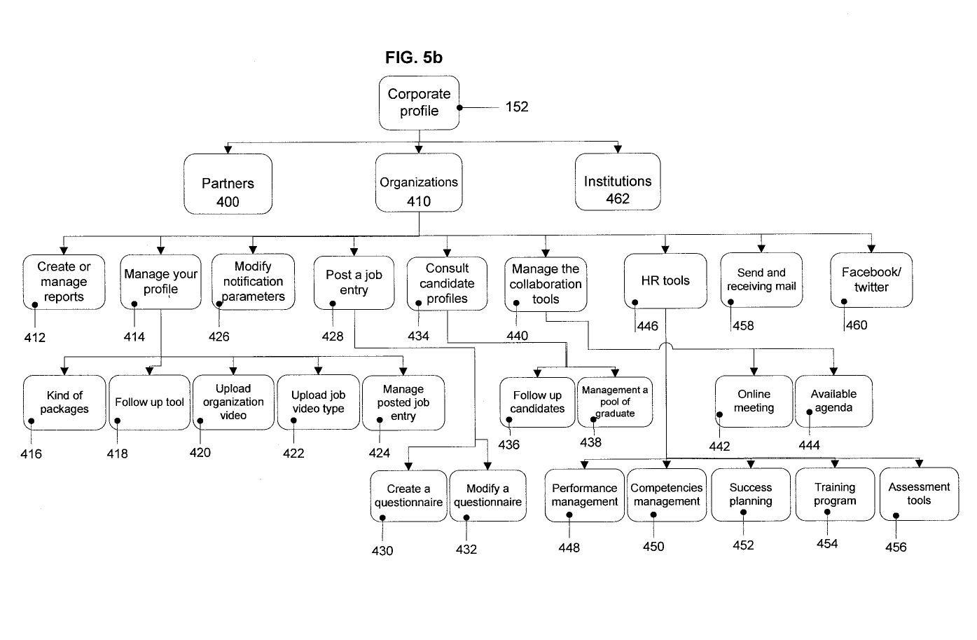

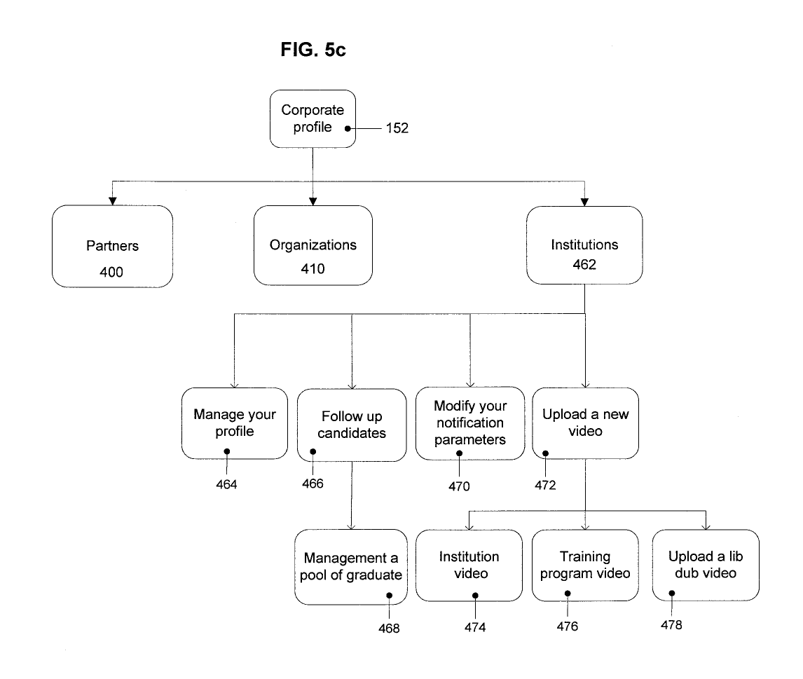

Referring to FIGS. 5a, 5b and 5c, there is a hierarchical functional block diagram of an exemplary corporate profile 152 of the system 30. Like a job seeker member, a corporate member may access its secure profile by entering the secure zone 50 and entering its user ID and password. In its profile 400, 462, a partner member or an institution member has several options including: managing its profile 402, 464, following up with candidates 404, 466, modifying its notification parameters 406, 470, and uploading a new video 408, 472. Further, the institution member may modify the information about its pool of past and future graduates 468, which is the number of students enrolled in each of its programs. The option to upload a new video 472 allows the institution member to upload videos about itself 474, videos about training programs or services offered by the member 476, and “lib dub” videos 478. A lib dub video is usually a video made by the employees of the institution to promote the institution.

The profile 410 of an organization member offers many options to the organization including: creating and managing reports 412, managing its profile 414, modifying its notification parameters 426, posting a job entry 428, consulting candidate profiles 434, managing collaboration tools 440, accessing HR tools 446, sending and receiving mail 458, and accessing social networking sites 460.

In one embodiment, an organization member may subscribe to one of many service packages, which will be described in more detail hereinbelow, and depending on the service package chosen by the organization, some or all of options 412, 414, 426, 428, 434, 440, 446, 458, 460 are available to the member. The member may also customize its service package by making a request to the system administrator to activate selected applications. In another embodiment, a partner or institution member may also subscribe to one of many service packages in order to access some or all of the functions offered by the system.

The information associated with each pictogram is stored in database 38, such that the database contains all pictogram information for all the jobs that are posted. Based on the pictogram information data and other types of data stored in database 38, the system may generate customized reports, for example, salary survey of a specific job in a particular geographical location, the range of experience required for a particular job, the jobs available in a specific field in a certain geographical region, or the like. Workflow mapping reports on recruitment processes and pre-selection stages may also be generated to help an organization view its progress in certain areas. The create or manage reports option 412 allows the organization member to request such customized reports from the administrator.

Under the managing profile option 414, the organization member may subscribe to a service package or modify its current subscription 416, use a follow up tool 418, include descriptions of the organization, including details on candidate preferences, use upload video tools 420, 422 to upload a video clip about the member organization or a job video about a job that is currently available or existing in the organization, and use a manage posted job entries tool 424 to modify posted job entries. The organization member may also upload a lib dub video. In an embodiment of the invention, the managing profile option 414 may also be available to institution members and partner members.

The organization member profile 410 allows the member to modify notification parameters 426 that were previously set by the member. The member may choose how it is to be notified of certain events such as when a user completes one of the member's questionnaires, when an eligible candidate requests or accepts an interview, or when a user submits a question or comment about the organization member or one of its jobs. Notification options may include SMS text message, email, electronic alert in its profile 410, and other means of notification as are known to those in this art. In one embodiment of the invention, the modify notification parameters option 426 may also be available to institution members and partner members.

Under the post a job entry option 428, the organization member may add a new job posting to the system 30 by entering basic information about the job, including whether the job is currently available, providing information associated with some or all of the pictograms, and uploading a video clip about the job. A posted job entry may be subsequently modified by the organization member under the manage posted entry option 424. For example, if a posted job becomes available, the member may change the job entry status accordingly, and in turn, the system 30 will automatically send a job alert 326 to all job seeker members who included this job entry in their profiles 150.

The post a job entry option 428 also provides the member the option to create a questionnaire 430 associated with the job that a user may complete to determine his eligibility as described above. The member may create his own questions for the questionnaire or use an assistant application available on the member profile 410 that helps the member create questions for the questionnaire.

The default setting allots equal weight to each question of the questionnaire but the member may adjust the weight of each question. As discussed above, after a job seeker completes the questionnaire by entering an answer for each question, the weight adjusted answers to the questionnaire are summed and, from the result, an evaluation algorithm generates an eligibility score. Exemplary methods for generating an eligibility score are as follows:

### EXAMPLE 1

Each answer of the questionnaire is assigned a score that is indicative of the importance of the question's subject matter to the organization:
Question 1: yes (3 points); no (0 points)
Question 2: yes (2 points); no (0 points)
Question 3: yes (4 points); no (0 points)
Question 4: yes (2 points); no (0 points)
Question 5: yes (0 points); no (3 points)
Question 6: yes (6 points); no (0 points)
Question 7: yes (6 points); no (0 points)
Question 8: yes (0 points); no (2 points)
If the user's answers to the questionnaire are:
Question 1: yes (3 points)
Question 2: no (0 points)
Question 3: yes (4 points)
Question 4: no (0 points)
Question 5: yes (0 points)
Question 6: no (0 points)
Question 7: yes (6 points)
Question 8: yes (0 points)
Adding up all the points accorded to the answers submitted by the user, the user's raw score is 13. The maximum possible score is 28. The user's eligibility score is therefore 13/28, which is approximately 46.4%.

### EXAMPLE 2

Each question is assigned a weight factor and each preferred answer is worth 1 point. The weight factor is indicative of the importance of the
question's subject matter to the organization.
Question 1: yes (1 point); no (0 points); (weight factor 0.25)
Question 2: yes (1 point); no (0 points); (weight factor 0.30)
Question 3: yes (1 point); no (0 points); (weight factor 3.20)
Question 4: yes (1 point); no (0 points); (weight factor 0.20)
Question 5: yes (0 points); no (1 point); (weight factor 2.50)
Question 6: yes (1 point); no (0 point); (weight factor 1.70)
Question 7: yes (1 point); no (0 points); (weight factor 0.40)
Question 8: yes (0 points); no (1 point); (weight factor 0.28)
If the user's answers to the questionnaire are:
Question 1: yes (1 point)
Question 2: no (0 points)
Question 3: yes (1 point)
Question 4: no (0 points)
Question 5: yes (0 points)
Question 6: no (0 points)
Question 7: yes (1 point)
Question 8: yes (0 points)
To get the raw score, the user's score for each answer is multiplied by the weight factor assigned to the corresponding question as follows, and the resultant scores are summed.
Question 1: 1 point×0.25=0.25
Question 2: 0 points×0.30=0
Question 3: 1 point×3.20=3.20
Question 4: 0 points×0.20=0
Question 5: 0 points×2.50=0
Question 6: 0 points×1.70=0
Question 7: 1 point×0.40=0.40
Question 8: 0 points×0.28=0
The user's raw score is 3.85. The maximum score is the sum of all the weight factors, which in this case is 8.83. The user's eligibility score is 3.85/8.83, which is approximately 43.6%.

The following is an exemplary pseudo code for generating a questionnaire:

```
Select create a questionnaire Yes/No
Insert a questionnaire name
Insert an eligibility threshold percentage
While there is question to add
      Insert a weight
      If the question is extremely important
          Update the information with value 100
      End if
      If the question is very important
          Update the information with value 80
      End if
      If the question is important
          Update the information with value 60
      End if
      If the question is less important
          Update the information with value 40
      End if
      If the question is not important
          Update the information with value 20
      End if
End While
```

The following is an exemplary pseudo code to carry out the evaluation algorithm:

```
Select Complete a questionnaire Yes/No
Select the related Job video questionnaire Yes/No
While there is question to answer
      Verify the answer yes (1) or no (0)
      If the answer is yes
          Update the information with value 1
          Multiply the answer value with the weight of question
      End if
      If the answer is no
          Update the information with value 0
          Multiply the answer value with the weight of question
      End if
Calculate the score
          Add the result
          Add 1 to counter
          Divide the results by the counter value
                Update the final score
End while
```

The profile application 410 also allows the member to save a questionnaire for subsequent completion or modification, prior to submitting the questionnaire for posting to the website. For a questionnaire that has already been posted, the member may subsequently modify the questionnaire 432 by adding or deleting questions or adjusting the weight of the questions. For each questionnaire, the organization member may also set and later adjust the eligibility threshold depending on changes in the organization's circumstances. If a change of eligibility threshold renders previously ineligible job seekers eligible, the system will notify the now eligible job seekers in accordance with their notification preferences, previously described. The eligible job seekers may then access the application process and apply for the corresponding job. After a job seeker completes a questionnaire and the results are forwarded to the corresponding organization member, the organization member may request a more detailed answer to any question in the questionnaire from the job seeker. This type of request may be sent to the job seeker by email, SMS text message, profile message, or the like.

The organization member profile 410 also provides other options to the member, such as following up on candidates after an interview 436 and consulting candidate profiles 434 to search for job seeker members who meet specific criteria or who have completed a certain questionnaire. For example, the organization member may conduct a search of the system database 38 for job seeker members who have listed the organization member's name under their profile preferences or have saved the organization's video clip in their profiles 150, or job seeker members whose education or work experience matches the organization's search criteria. The organization member may also search for job seekers who scored above a certain eligibility score, regardless of whether that score meets the corresponding preset eligibility threshold. After a search is conducted and search results are generated, the application allows the organization member to save the search results; to form a general or job-specific candidate group by selecting job seekers from the search results and saving the selections; to view information about a job seeker selected from the search results; to contact a selected job seeker in accordance his notification preferences; to send an alert or a video clip to the profile or mobile device of a selected job seeker; to request a selected job seeker to take a psychometric test; to request and schedule a meeting with a selected job seeker; and to offer a job to a selected job seeker. Although the organization member may view a job seeker's information, the organization may not be provided with the job seeker's identity which allows job seekers to remain anonymous until they attend a job interview. The meeting or interview between the organization and selected job seeker may be in person or by live chat or WebConference™. The organization member also has the option to export the search results or a saved candidate group. The search results saved in the profile 410 may be subsequently modified and deleted by the organization member.

Under the pool of past and future graduates option 438 of profile 150, the member may view information about the number of students who have completed and/or who are enrolled in a specific educational or training program.

The organization member may manage collaboration tools 440, including activating online communication tools 442 such as live chat, NetMeeting™, WebConference™, discussion forum, and/or blog, and managing and updating its interview availability agenda 444 that may be accessed by an eligible job seeker. The profile application 410 provides the organization member with a catalogue of services offered by partners, including electronic HR tools 446 such as performance management tools 448, competency management tools 450, success planning tools 452, training programs 454, and assessment tools 456. The system allows the member to directly contact a service provider.

The profile application 410 allows the organization member to create and send electronic messages to email addresses or to other member accounts, and also to receive electronic messages from other members 458. From its profile 410, the organization member may also access its accounts on other social networking sites 460, such as Twitter™, Facebook™, or the like.

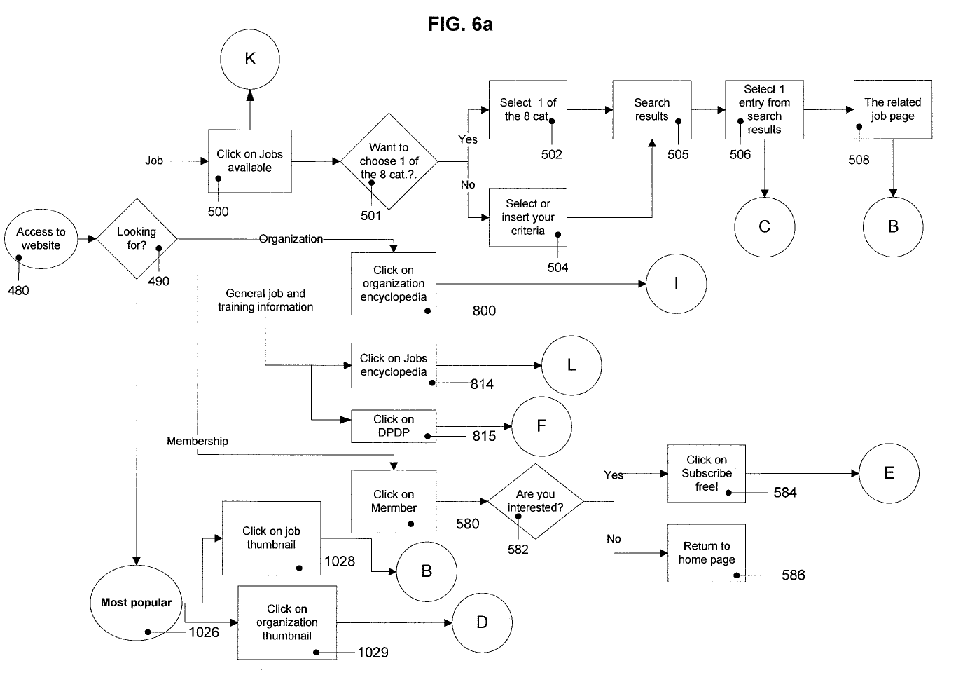

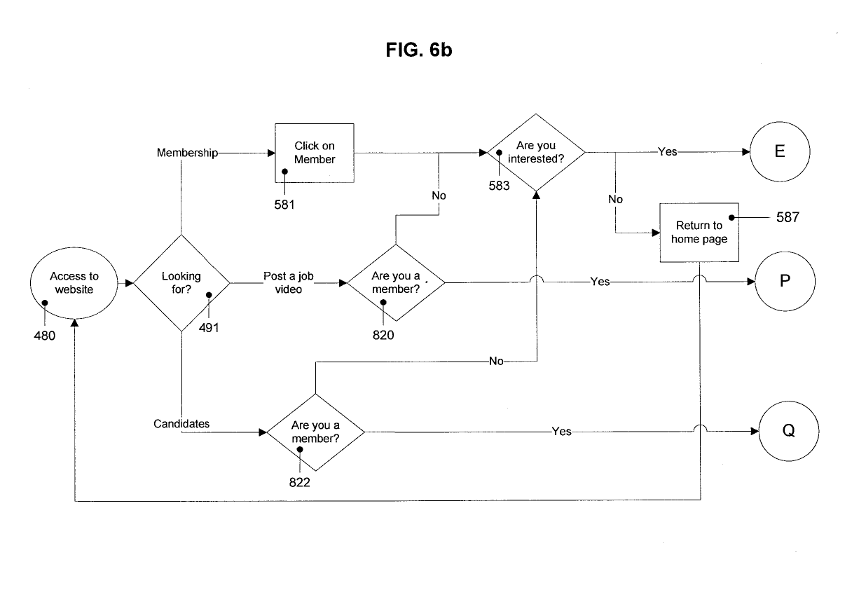

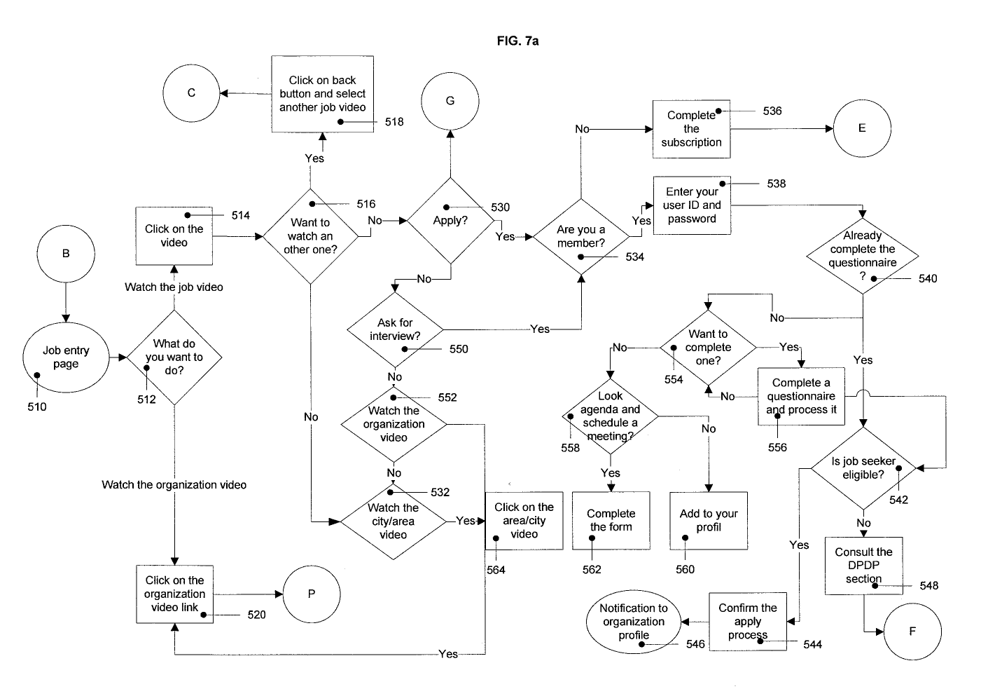

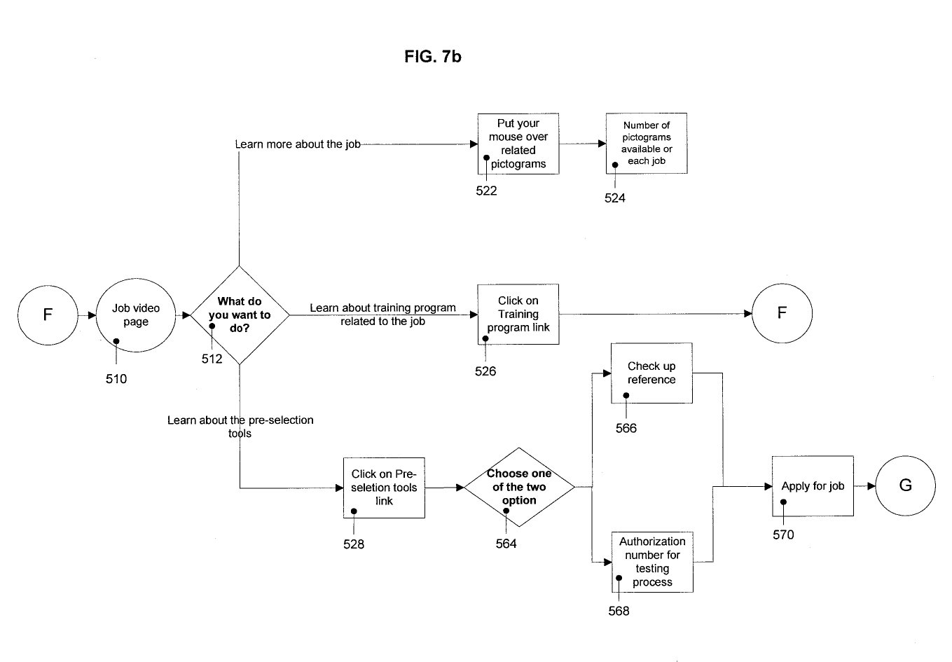

Referring to FIGS. 6a, 7a and 7b, there are shown block flowcharts which illustrate exemplary processes performed by a user of the website of the system 30. The processes begin when a user, who is a job seeker, accesses the system's website at step 480. At step 490, the job seeker chooses among the available options, which include jobs available, organization encyclopaedia, jobs encyclopaedia, directory of professional development programs, membership, and most popular entries. When the job seeker selects jobs available (step 500), the job seeker has the option of searching by categories or by criteria (step 501). Whether the job seeker chooses search by category (step 502) or search by criteria (step 504), the system will return the search results at step 505 in the form of a list of job entries, each job entry being represented by an illustrative image, such as an icon or thumbnail, of a corresponding video clip of the job entry. At step 506, the job seeker selects one of the illustrative images from the search results and he is redirected to the corresponding job entry page (step 508). At the job entry page (step 510), the job seeker is presented with several options at step 512: select the job video (step 514), select the organization video link (step 520), activate pictograms (step 522), select training program link (step 526), and select pre-selection tools link (step 528). The job seeker may watch the job video by selecting the video window at step 514. If the job seeker wants to watch another job video (step 516), he may select the back button to return to the search results from which he may select another job entry illustrative image (step 518) and this will take the job seeker back to step 506.

If the job seeker does not want to watch another job video at step 516, the job seeker may proceed to step 530 (option to apply for the job) or to step 532 (to watch a video clip about the city or area where the job is located). If the job seeker elects to watch a video clip about the city or area where the job is located by selecting the corresponding link or illustrative image (step 532), a video clip window will appear and the job seeker may play the video by selecting the window (step 564). At step 530, if the job seeker chooses to apply for the job, the system 30 will request the job seeker to confirm his membership (step 534). If the job seeker is not a member, the system will direct him to step 536 where he may proceed to registering for a membership. The process for obtaining a membership will be discussed in detail hereinbelow.

If the job seeker is a member, he may proceed to step 538 where he is requested to login by enter his user ID and password. Once the system 30 verifies the login information, the system will ask the job seeker whether he has completed the questionnaire associated with the job (step 540). If the job seeker has already completed the questionnaire, the system will then direct the job seeker to step 542 where the job seeker is shown his eligibility for the job (i.e. whether the job seeker's eligibility score from the questionnaire meets the employer organization's eligibility threshold). If the job seeker is not eligible for the job, the system will prompt the job seeker to consult the directory of professional development programs (step 548), the process for which will be described in further detail hereinbelow. If the job seeker is eligible for the job, the system will prompt the job seeker to being an application process by asking the job seeker to confirm that he wants to apply for the job (step 544). Once the job seeker confirms his application, the system will send a notification to the employer organization's profile (step 546).

At step 540, if the job seeker has not completed the questionnaire associated with the job, he will be prompted by the system to complete the questionnaire at step 554. If the job seeker agrees to complete the questionnaire, he may then proceed to complete the questionnaire (step 556). The system will then process the answers to derive the job seeker's eligibility score (step 556) and proceed to step 542 to assess whether the job seeker is eligible for the job.

At step 554, if the job seeker decides not to complete a questionnaire, he may proceed to the option of reviewing the agenda of the employer organization and scheduling a meeting (step 558). If the job seeker wants to schedule a meeting, the system will prompt him to complete an online form (step 562). Otherwise, the job seeker may proceed to add the job entry or job video to his member profile (step 560).

If the job seeker does not choose to apply for the job at step 530, the job seeker may instead choose to ask for an interview (step 550) and proceed to step 534 (confirmation of membership). If the job seeker chooses not to ask for an interview at step 550, the job seeker may proceed to watch a video clip about the employer organization at step 552. The job seeker may watch the video by selecting the organization video link or illustrative image (step 520). If the job seeker chooses not to watch the organization video at step 552, then he may proceed to step 532 to watch a video clip of the city or area where the job is located by selecting the video clip (step 564).

At the job entry page (step 510), the job seeker may proceed directly to step 526 by selecting the link for directory of professional development programs and he will then be redirected by the system 30 to the directory of professional development program process, which will be described in detail below. Also from the job entry page (step 510), the job seeker may select the pre-selection tools link (step 528) and the system will present the job seeker with two options (step 564): check up reference (step 566) and testing process (step 568) At both steps 566 and 568, the job seeker will be provided with information, such as login ID and password or authorization code, or a link for connecting to a secure website of a partner member. If the job seeker proceeded from step 566, the job seeker will be prompted to submit reference information, after logging on to the partner website. Such reference information may be then given to employer organizations by the partner member. If the job seeker proceeded from step 568, the job seeker will be prompted to complete online tests via the partner's website. The selection of either option will prompt the job seeker to apply for the job (step 570) and the job seeker will be directed to step 530.

At the job entry page (step 510), the job seeker may access more information about the job by proceeding directly to step 522 by activating a pictogram of the loop of pictograms, as described above. The job seeker may review a predetermined number of pictograms (step 524).

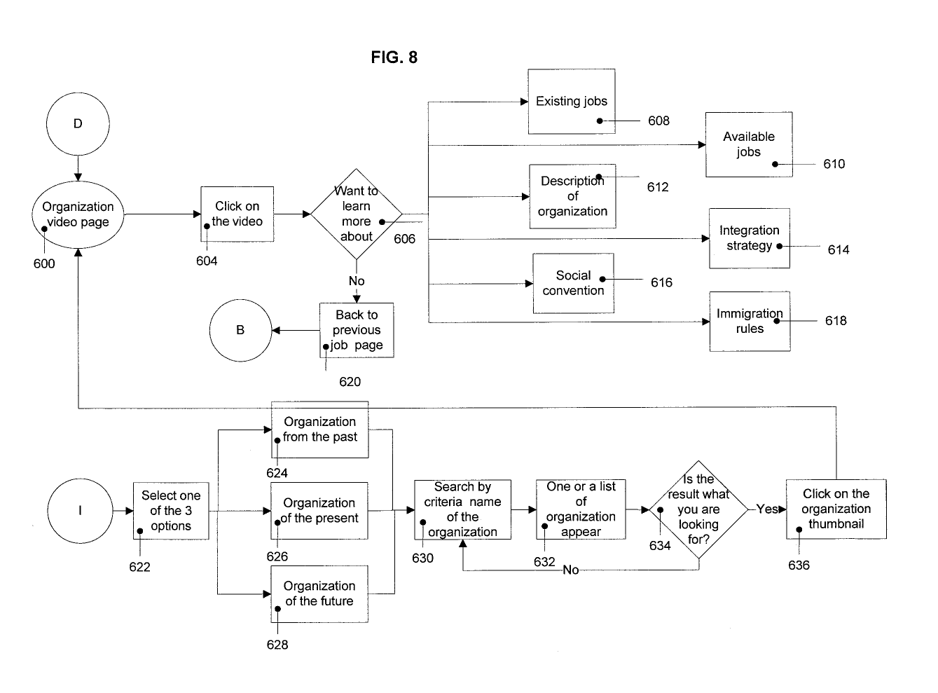

Referring to FIGS. 7a and 8, there are shown block flowcharts illustrating exemplary processes performed by a user of the website of the system 30. From the job entry page (step 510), a job seeker may proceed directly to step 520 by selecting the link to or illustrative image of the video clip about the employer organization. The job seeker will then be directed to the organization video page (step 600). At step 604, the job seeker may watch the organization video by selecting the video window. From step 604, the job seeker is presented with a number of options (step 606): watch a video about an existing job of the organization (step 608), watch a video about an available job of the organization (step 610), read text information about the organization (step 612), view the integration strategies (step 614), view social conventions (step 616), view immigration rules (step 618), and return to job entry page (step 620) or home page.

If the job seeker chooses to proceed to step 608, the job seeker may watch a video clip about a job that is exists within the organization by selecting that particular job video from the list of video clips of existing jobs shown on the organization video page (step 600). Likewise, at step 610, the job seeker may watch a video clip about a job that is currently unfilled within the organization by selecting that job video clip from the list of video clips of available jobs shown on the organization video page. At step 612, the job seeker may read the text description about the organization shown on the organization video page.

When a pictogram on the organization video page is activated, as described above, a text box will appear in front of the pictogram to provide the job seeker with information on, for example, the culture of the organization and tips on how to fit into the organization (step 614), the cultural and social customs of the country or region where the organization is located (step 616), or the legal and government procedures that the job seeker would have to follow in order to work in the country or region where the organization is located (step 618).

From step 606, the job seeker may also choose to return to the previous page (step 620) or the home page and the system will redirect the job seeker accordingly depending on the job seeker's selection.

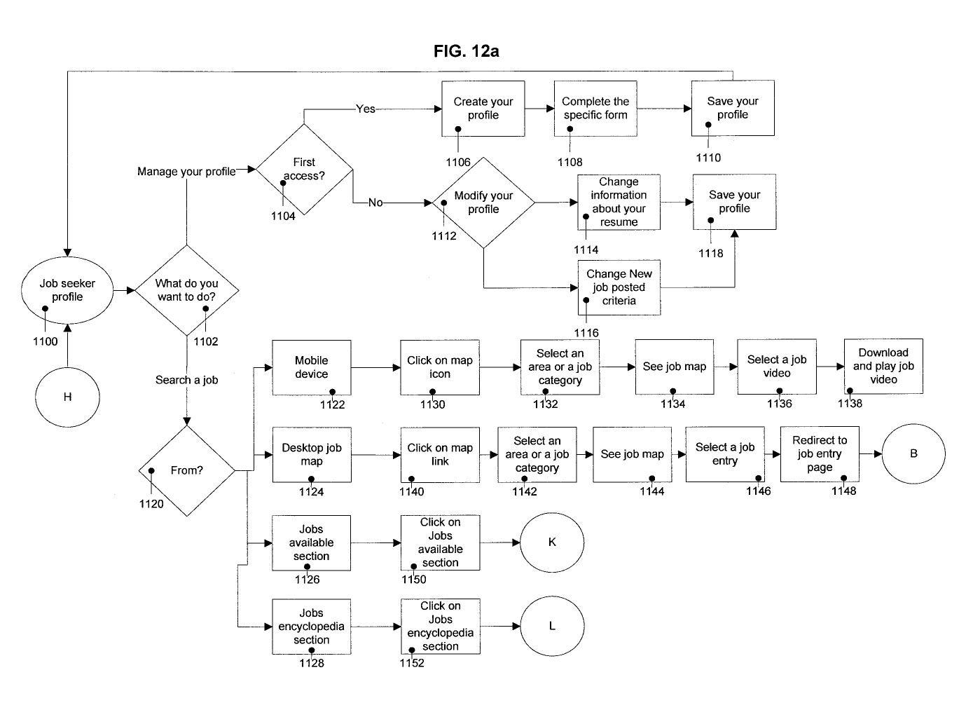

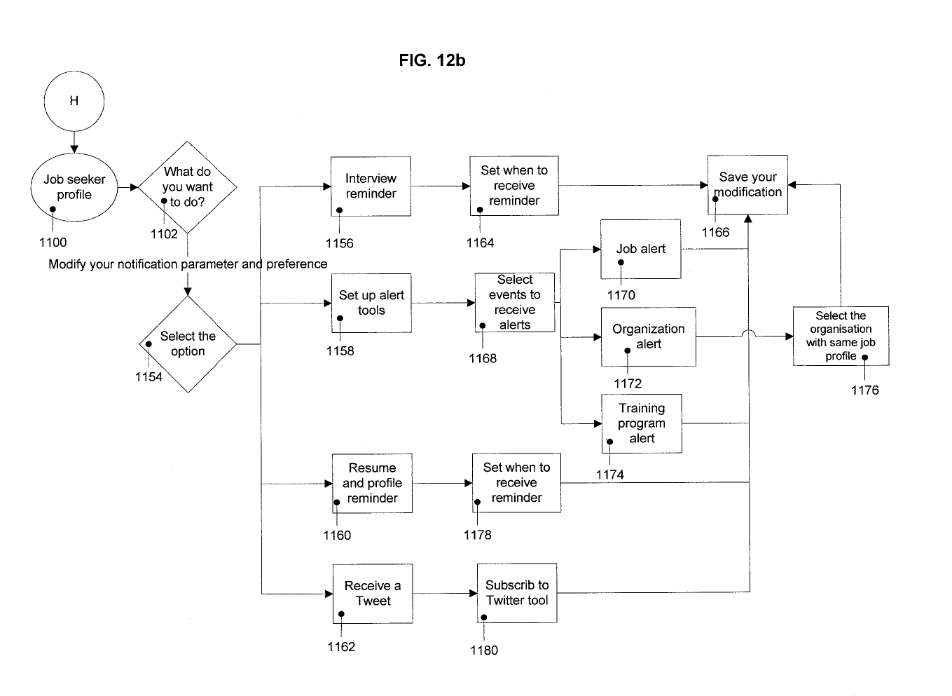

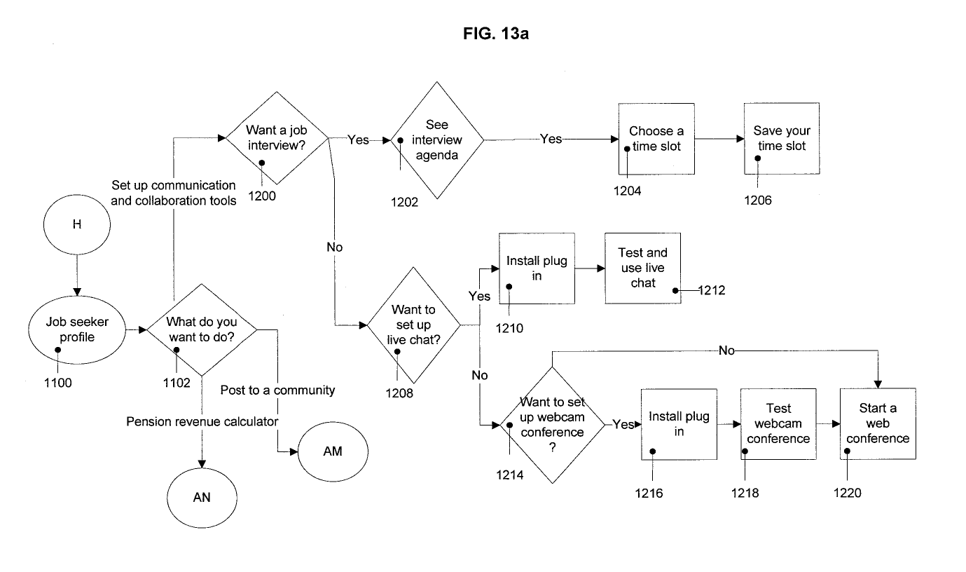

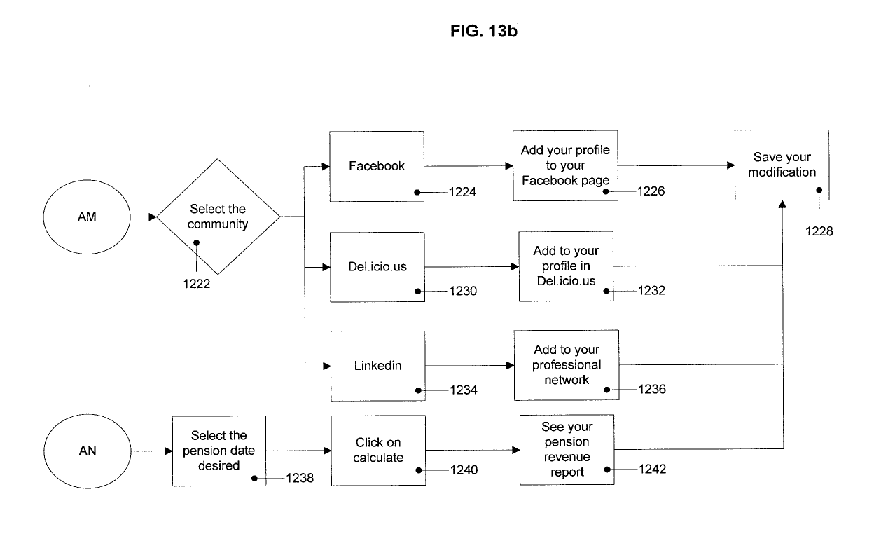

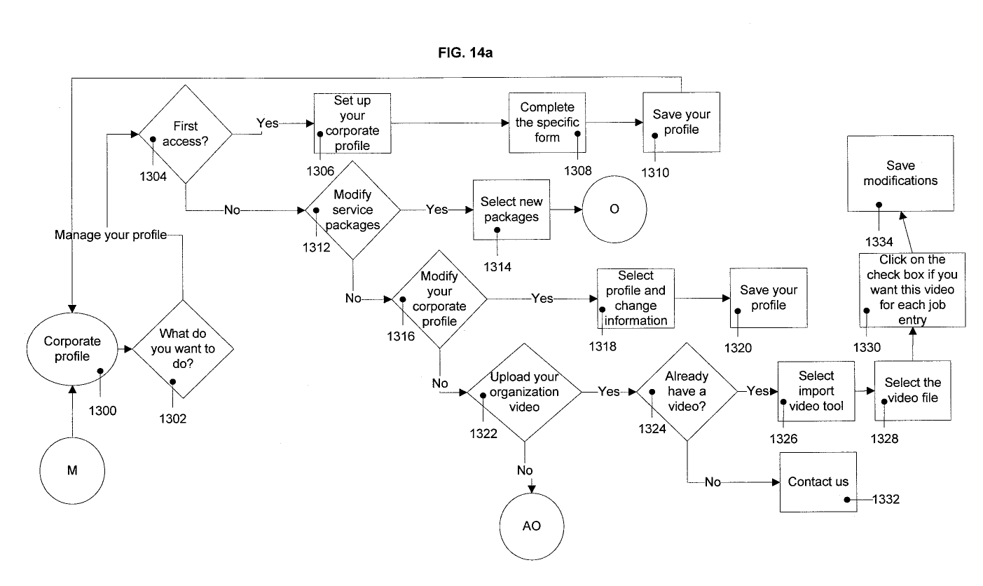

Referring to FIGS. 7a, 9, 12a, 12b, 13a and 13b, there are presented block flowcharts showing exemplary processes performed by a user of the website of the system 30. If a job seeker chooses to register for a membership at step 536, the system will direct the job seeker to the membership page (step 700) and the user will select the type of membership he wishes to register for (step 702). After selecting a job seeker membership (step 704), the system will provide the job seeker with an online registration form at step 706. After completing the online registration form (step 706), the job seeker will be provided with, or requested to set up, his user ID and password, and then he may proceed to step 708 to activate his account and set up his profile, which are discussed in detail hereinbelow.

At step 708, the system redirects the job seeker to his personal profile page (step 1100) after he enters his user ID and password. From his profile page, he may choose from several options (step 1102) including managing his profile, searching for a job, modifying his notification parameters and preferences, setting up communication and collaboration tools, posting to an online community, and using the pension revenue calculator. If the job seeker chooses to manage his profile from step 1102, he will be directed to step 1106 to set up his profile if it is his first time accessing his profile page (step 1104). Setting up his profile may require the job seeker to enter information about himself such as biographical information and work experience information, which may be done by way of completing an electronic form (step 1108) or uploading a copy of the his resume. In his profile, the job seeker may also indicate whether he is a helper for the homework help program or a tutor and/or mentor, as described in detail above. The profile setup process may also require the job seeker to enter information about his job preferences and organization preferences, since the system 30 may alert the job seeker about any new job postings that correspond to the job seeker's job and organization preferences. After entering his information, the job seeker may proceed to step 1110 to save the information on his profile. If the job seeker has already accessed his profile page before and has previously set up his profile, the job seeker may proceed to modify his profile (step 1112) by either changing his biographical and work experience information (step 1114), or his job and employer preferences (step 1116), including adding and deleting entries or video clips of jobs and organizations from his profile. The job seeker may then save the changes made to his profile at step 1118.

At step 1102, the job seeker may choose to search for a job and there are a number of tools available to him (step 1120), including: mobile device job map (step 1122), desktop job map (step 1124), jobs available database (step 1126) and jobs encyclopaedia (step 1128). The mobile device job map tool (step 1122) allows the job seeker to access, using a mobile device, a web mapping application showing the locations of jobs that may be of interest to the job seeker, depending on the parameters set by the job seeker, as described in detail above. The job seeker may access the mapping application by selecting the corresponding icon (step 1130). Next, the job seeker may set the map parameters, e.g. a geographical area or a job category (step 1132), in order for the mapping application to display the relevant map to the job seeker (step 1134). At step 1136, the job seeker may select a job from the map and the corresponding job video will be uploaded to the job seeker's mobile device for the job seeker's viewing (step 1138).

The job seeker may also access the mapping application from a desktop computer (step 1124) by selecting the corresponding link (step 1140). To choose the type of map he wishes to view, the job seeker may set the map parameters, e.g. geographical area or job category (step 1142). After viewing the map (step 1144), the job seeker may select a job illustrative image from the map (step 1146) and be automatically redirected to the corresponding job entry page (step 1148), where he can view the corresponding job video clip.

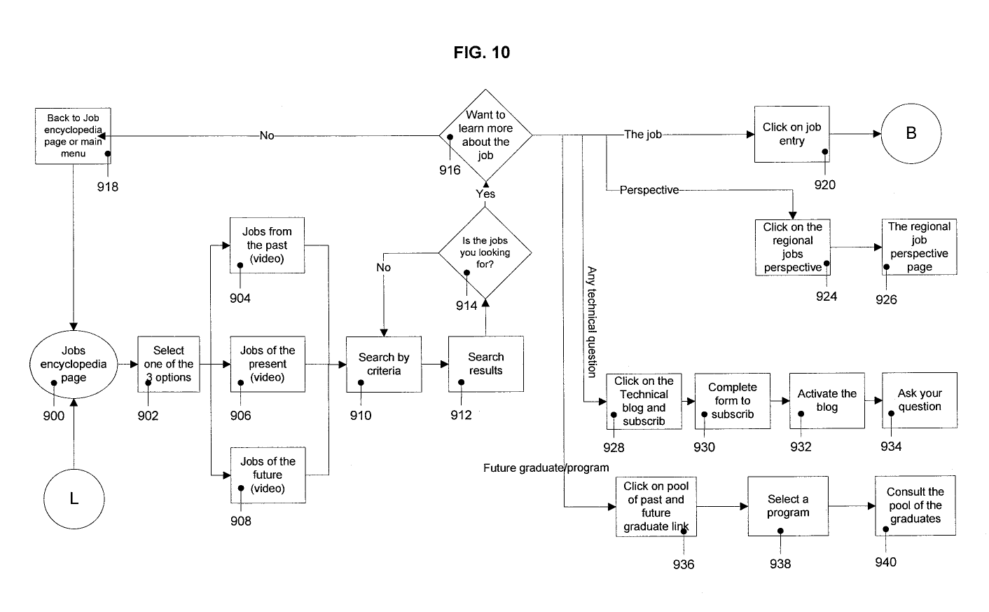

At step 1120, the job seeker may also choose to search for jobs using the jobs available option (step 1126) selecting the corresponding link (step 1150) and be automatically redirected to the jobs available search option at step 500 (FIG. 6a). Likewise, the job seeker, at step 1120, may choose to search the jobs encyclopaedia (step 1128) by selecting the corresponding link (step 1152) and be redirected to the jobs encyclopaedia page at step 900 (FIG. 10). The jobs encyclopaedia search process will be described in detail hereinbelow.

At step 1102, the job seeker has a number of options for modifying his notification parameters and preferences (step 1154) including interview reminder (step 1156), alert tools (step 1158), resume reminder (step 1160), and receive Tweet™ communications (step 1162). The interview reminder option (step 1156) is where the job seeker may set up an electronic reminder by selecting the type of reminder (e.g. text message, email, or the like) and when the reminder is to be sent to the job seeker in order to remind the job seeker about an upcoming interview (step 1164). If the job seeker selects the alert tools option (step 1158), he may select the events for which he wishes to receive alerts and the type of alert he prefers (step 1168). For instance, the job seeker may choose to receive alerts for jobs (step 1170), which would provide an alert to the job seeker when a job of interest becomes available or when the job seeker become eligible for a job of interest. At step 1172, the job seeker may also choose to receive alerts when an organization listed in his preferences posts a new job or updates its organization profile. From step 1172, the job seeker may further view other organizations that have the same type of jobs as those available in a selected organization from the job seeker's list of preferred organizations (step 1176). The job seeker may choose to receive a training alert (step 1174), which sends an alert to the job seeker when changes are made to a training program listed in the job seeker's preferences or when an institution or partner in the job seeker's preferences updates the corresponding institution's or partner's profile. If the job seeker selects the resume reminder option (step 1160), he may set up periodic alerts to remind himself to update his resume or work experience information on his profile or other information on his profile (step 1178). At step 1178, the job seeker may choose when (e.g. time period from the last modification) or how frequently he is to receive a resume reminder alert. The job seeker may select how he is to be alerted for each event. The types of alert includes emails, text messages, and other forms of electronic alerts as known in the art.

From step 1162, the job seeker may also subscribe to a service such as Twitter™ (step 1180) to receive an electronic alert, such as an email or SMS text message, when the administrator posts updates using the Twitter™ service. The updates may relate to new functionalities of the system's website, new events such as job fairs and education fairs, and upcoming events.

At step 1102, if the job seeker chooses to set up a job interview (step 1200), he may proceed to step 1202 to check the interview agenda of the corresponding employer organization for available time slots. The system allows the job seeker to reserve an available time slot for the job interview by selecting (step 1204) and saving the time slot (step 1206) on his profile.

At step 1102, the job seeker may also set up live chat (step 1208) and web conference (step 1214). If the job seeker chooses to set up live chat (step 1208), the system will prompt the job seeker to install the appropriate plug in (step 1210) and then the job seeker may test and use the live chat tool (step 1212). If the job seeker chooses to set up web conference (step 1214), the system will prompt the job seeker to install the appropriate plug in (step 1216) if one has not already been installed on the job seeker's computer, and the jobs seeker may proceed to test the web conference tool (step 1218). If a plug in was previously installed, the job seeker may proceed to start a web conference (step 1220) directly from step 1214.

At step 1102, the job seeker may choose to post information to an online social networking site by selecting, at step 1222, a particular networking site to post on. The networking sites that the job seeker may choose from may include: Facebook™ (step 1224), Del.icio.us™ (step 1230), and LinkedIn™ (step 1234). Provided that the job seeker has an account on the selected networking site, the job seeker may add his profile to his account (step 1226, 1232, 1236) so that his profile is accessible from his account on the selected networking site. Once the job seeker adds his profile to a networking site, he may save the addition at step 1228.

If the job seeker chooses to access the pension revenue calculator from step 1102, the system will prompt the job seeker to enter a pension date and other relevant information (step 1238), if such information is not already present in the job seeker's profile. After entering and reviewing the information, the job seeker may request a pension revenue report by selecting the appropriate link or icon (step 1240) and then proceed to view the pension revenue report generated by the system from the provided information (step 1242).

Referring to FIGS. 6a and 8, there are presented block flowcharts showing exemplary processes performed by a user of the website of the system 30. At the home page (step 480), a user who is a job seeker has several options (step 490) and if the job seeker selects organization encyclopaedia (step 800), the system will direct the job seeker to step 622, where the job seeker may start a search by selecting one out of the three categories of organizations: past (step 624), present (step 626), and future (step 628). After a category is selected, the job seeker will then be prompted to enter search criteria (step 630), for example, by selecting an organization name from a preset list or by using the organization name as the search criterion. In one embodiment, the job seeker may also search by location, industry, and field of technology. At step 632, the system performs a search based on the information entered by the user and provides the user with search results, which may be one or more illustrative images, such as an icon or a thumbnail, representing the video clip(s) of the organization(s) that corresponds to the search criteria. At step 634, the job seeker may review the search results and decide whether the results include the organization(s) that he is looking for. After reviewing the results (step 634), the job seeker may select one of the illustrative images (step 636) and be directed to the corresponding organization video page (step 600). From step 600, the job seeker may proceed as described above. At step 634, if the job seeker does not find the organization he is looking for in the search results, he may choose to search again and the system will direct the user to step 630.

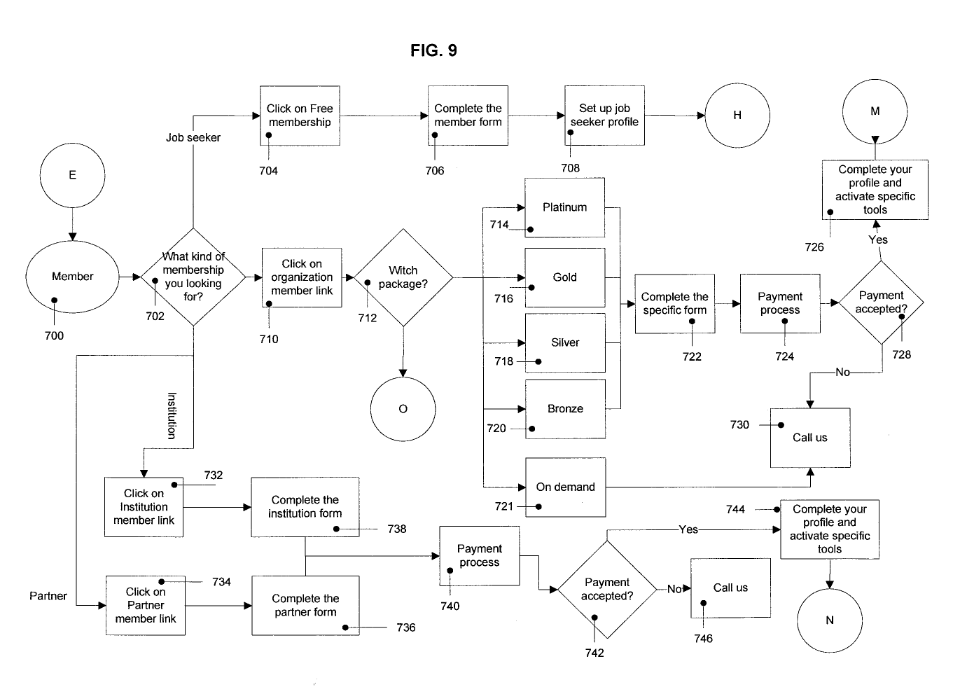

Referring to FIGS. 6a and 9, there are presented block flowcharts showing exemplary processes performed by a user of the website of the system 30. At the home page (step 480), a user, who is a job seeker, is presented with several options (step 490). If the user selects the membership link (step 580), he is asked to confirm whether he wishes to proceed to register for a membership (step 582). To confirm that he wishes to register for a membership, the user must select the link to the membership page (step 584) and then the system will direct the user to the membership page (step 700). At the membership page (step 700), the user may choose among different types of memberships (step 702), for example, a job seeker membership (step 704), an organization membership (step 710), an institution membership (step 732), and a partner membership (step 734). If the user selects a job seeker membership (step 704), the user may complete a online registration at step 706 and proceed to the subsequent steps as described above. If the job seeker is not interested in obtaining a membership, he may return to the home page at step 586.

Referring to FIGS. 6a and 10, there are presented block flowcharts showing exemplary processes performed by a user of the website of the system 30. From step 490, the user who is a job seeker may select the jobs encyclopaedia link (step 814) and be directed to the jobs encyclopaedia page (step 900). At step 902, the job seeker may choose to search one of the three categories of jobs: the past (step 904), jobs of the present (step 906) or jobs of the future (step 908). After selecting a category, the job seeker will then be prompted to enter search criteria (step 910), for example, geographical regions, industries, technical fields, salary range, level of education required, or the like. For jobs of the present, the job seeker may also search by job categories (e.g. full-time, part-time, on-call work, self-employment, or the like). At step 912, the system performs a search in accordance with the criteria entered by the job seeker and returns search results in the form of a list of one or more job entry illustrative image. After reviewing the search results, the job seeker may choose to start another search if the search did not return any results that the job seeker is looking for (step 914) and the system will redirect the job seeker back to step 910. At step 914, if the search did locate a job that the job seeker is looking for but the job seeker decides not to learn more about the job (step 916), then the system will direct the job seeker to step 918, where the job seeker may return to the jobs encyclopaedia page (step 900) or the homepage (step 480). However, if the job seeker decides to learn more about the job (step 916), he may proceed to one of four options. First, the job seeker may select the job entry illustrative image (step 920) to access the job entry page. Second, the job seeker may select the link to regional jobs statistical perspective (step 924) to access the regional job perspective page (step 926), where information on unemployment rates, trends, statistics on manpower needs, or the like, for the geographical region where the job is located is available for the job seeker's review. Third, the job seeker may select the link to the technical forum (step 928). If the job seeker is not a member, the system may prompt the job seeker to subscribe for a membership (step 930) prior to allowing access to the technical forum. After subscribing, the job seeker may activate the forum application (step 932) and then post his question or comment on the forum (step 934). Fourth, the job seeker may select the link to pool of past and future graduates (step 936) and be directed to the pool of past and future graduates page, where the job seeker may select a program (step 938). After selecting a program, the job seeker may proceed to consult the pool of past and future graduates for that program (step 940), which provides information on the number of students who have completed and/or who are enrolled in a specific educational or training program.

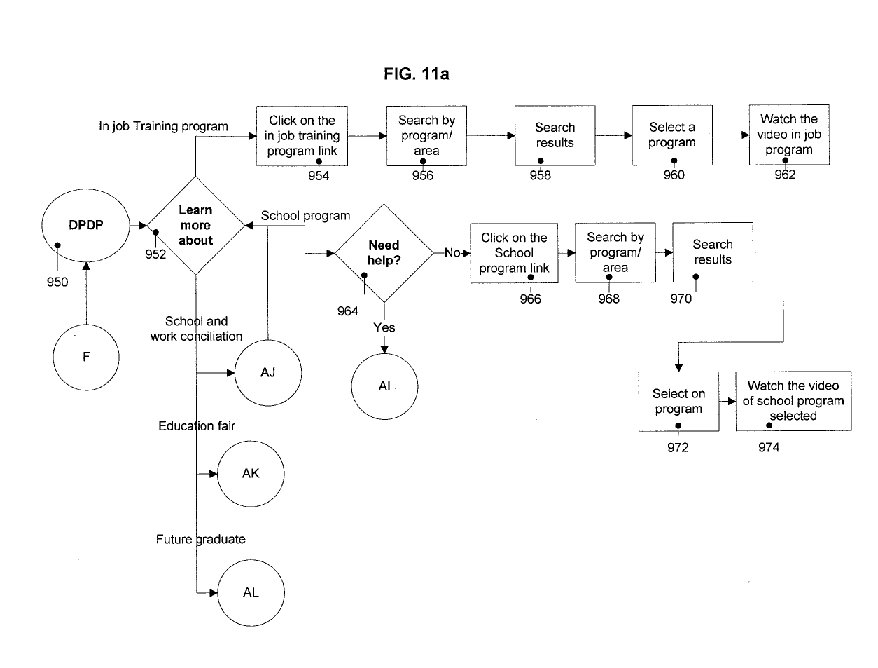

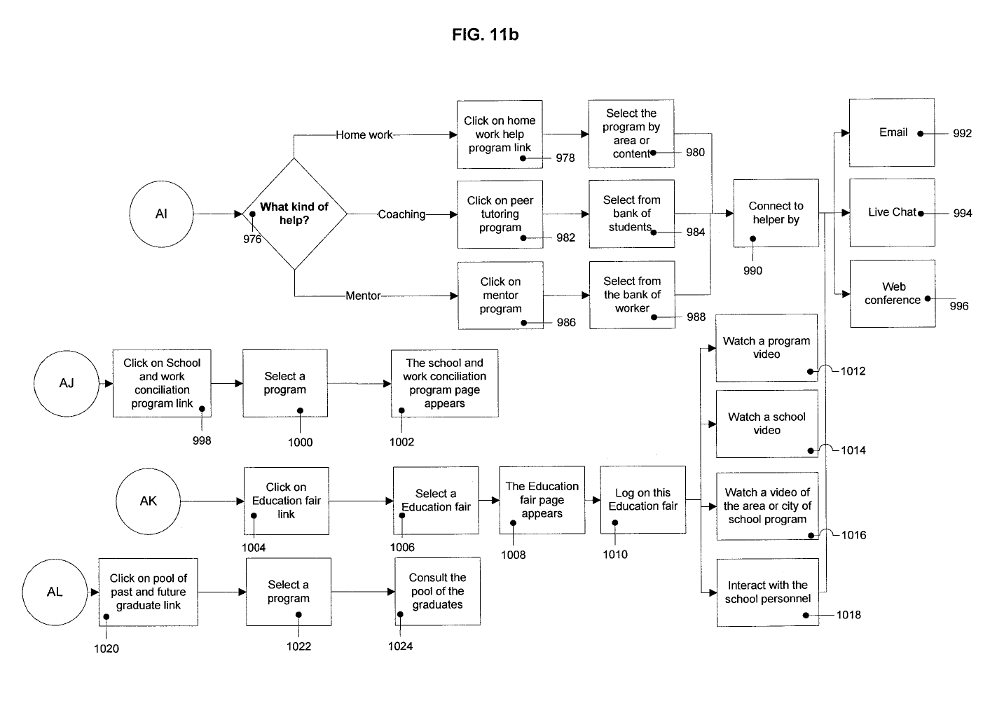

Referring to FIGS. 6a and 11, there are presented block flowcharts showing exemplary processes performed by a user of the website of the system 30. From step 490, the user who is a job seeker may select the directory of professional development program link (step 815) and be directed to the directory of professional development programs page (step 950). From step 950, the job seeker may be provided with several options (step 952), which may include: directory of institutions and training partners, in job training program, school program, school and work conciliation, and education fair.

By selecting the link for job training program (step 954), the job seeker may search for a program by the program name, by geographical location, and by institution name or partner name (step 956). At step 958, the system conducts a search based on the criteria entered by the job seeker and returns the search results in the form of a list of job training program illustrative images. The job seeker may select an illustrative image from the list (step 960) to watch the training program video clip (step 962). The job seeker may also have the option to watch a video clip of the corresponding institution or partner at step 962.

From step 952, the job seeker may have the choice of either searching for school programs or requesting assistance for school programs (step 964). To search for school programs, the job seeker may select the school program link (step 966) and search by the name of the program or by geographical region (step 968). The system then performs a search based on the limitations entered by the job seeker and returns search results in the form of a list of illustrative images of school programs (step 970). When the job seeker selects one of the illustrative images (step 972), the corresponding school program video clip will appear and play for the job seeker's viewing (step 974).

At step 964, if the job seeker chooses to request assistance for school programs, he will be asked to select one of three types of assistance (step 976): homework help programs (step 978), peer tutoring programs (step 982), and mentorship programs (step 986). At step 976, if the job seeker selects the link for homework help programs (step 978), he may then proceed to step 980 to select a program from a list, which may be categorized by geographical location, by school subject, or technical field. After a selection is made at step 980, the system will provide options for the job seeker to connect with the program operators (step 990), including by email (step 992), by live chat (step 994), or by web conference (step 996).

At step 976, if the job seeker selects the link for peer tutoring programs (step 982), the system will select an available student tutor from a bank of student tutors (step 984) and then provide options for the job seeker to connect with the selected student tutor (step 990). The selected student tutor's consent may be sought by the system or administrators prior to allowing the job seeker to contact the tutor. The job seeker may contact or meet with the student tutor by email (step 992), by live chat (step 994), or by web conference (step 996).

At step 976, if the job seeker selects the link for mentorship programs (step 986), the job seeker will be prompted to elect the area of expertise (e.g. industry or technical field) in which the job seeker is seeking mentorship. Depending on the elected area of expertise, the system will then select an available mentor, and may seek the selected mentor's consent prior to providing options for the job seeker to connect with the mentor (step 990). The job seeker may contact or meet with the mentor by email (step 992), by Live Chat (step 994), or by web conference (step 996).

At step 952, if the job seeker selects the link to school and work conciliation programs (step 998), the job seeker will be directed to step 1000, where he may be provided with a list of illustrative images of the available programs from which he may make a selection. If the job seeker selects one of the illustrative images (step 1000), a corresponding webpage will appear (step 1002), wherein a video clip may be provided for the job seeker's viewing.

At step 952, the job seeker may select the link for education fair (step 1004) and proceed to view and select from a list of education fairs (step 1006). Any of the education fairs may be hosted by an institution or a partner, rather than by the administrator. If the job seeker selects one of the education fairs at step 1006, the corresponding education fair webpage will appear for the job seeker's viewing at step 1008. At step 1010, the job seeker may be required to log on in order to view the education fair. The log on information may be provided to the job seeker by the host of education fair. After logging on to the education fair webpage (step 1010), the job seeker has several options including watching an education program video (step 1012), watching a school video (step 1014), watching a video about the city or area where a school program is being offered (step 1016), and contacting a school personnel (step 1018). The job seeker may contact or meet with the school personnel by email (step 992), by live chat (step 994), or by web conference (step 996).

At step 952, the job seeker may select the pool of past and future graduates option by selecting the corresponding link (step 1020) and proceed to select a program (step 1022). After selecting a program (step 1022), the system then provides the job seeker with the number of students who have completed and/or who are currently enrolled in the selected program, based on information provided by the corresponding institution(s) (step 1024). In one embodiment, the pool of past and future graduates option may not be available to job seekers and may only be accessible by corporate members.

Referring to FIGS. 6a, 7a and 8, there are presented block flowcharts showing exemplary processes that may be performed by a user of the website of the system 30. At the homepage (step 480), the system displays a list of illustrative images of the jobs and organizations that have the most-viewed video clips (step 1026). If the user selects one of the job illustrative images (step 1028), the system will redirect the user to the corresponding job entry page (step 510). Likewise, if the user selects one of the organization illustrative images, the system will direct the user to the corresponding organization video page (step 600). The list of most popular video clips may also appear on pages other than the homepage.

Referring to FIGS. 6b and 9, there are presented block flowcharts showing exemplary processes performed by a user of the website of the system 30. At the home page (step 480), a user who is a partner, an institution or an employer organization has several options (step 491), including membership (step 581), post a job video (step 820), and search for candidates (step 822). If the user selects the membership link (step 581), it is asked to confirm whether it wishes to proceed to register for a membership (step 583). If it confirms its interest in registering for a membership, the system will direct the user to the membership page (step 700). If the user is not interested in obtaining a membership, the user may choose to return to the home page (step 587) and then be directed to step 480.

At the membership page (step 700), the user may choose among different types of memberships (step 702), for example, a job seeker membership (step 704), an organization membership (step 710), an institution membership (step 732), and a partner membership (step 734). If the user selects institution membership (step 732), he may complete the online registration form for institutions (step 738) and then proceed to pay the membership fee at step 740. Likewise, if the user selects partner membership (step 734), he may complete the online registration form for partners (step 736) and then proceed to pay the membership fee at step 740. At step 742, the system processes the payment and if the payment is accepted, the user will be directed to step 744, where he may set up his member profile and activate his account. The details of setting up a member profile are discussed below. If the payment is not accepted at step 742, the user will be provided with the contact information of the administrator and be invited to contact the administrator (step 746).

If the user selects the organization membership link (step 710), the user will be asked to select one of several service level packages (step 712), for example: platinum package (step 714), gold package (step 716), silver package (step 718), and bronze package (step 720). After selecting a service level package, the user may complete an online registration form specific to the service level package selected (step 722) and then proceed to pay the corresponding membership fee (step 724). At step 728, the system processes the payment and if the payment is accepted, the user may then proceed to complete the member profile and activate his account and associated applications (step 726). If the payment is not accepted, the system will provide the user with the administrator's contact information and invite the user to contact the administrator (step 730). At step 712, the user may also decide to customize its own service package (step 721) by contacting the administrator (step 730). In one embodiment of the invention, institution members and partner members may have the option of subscribing to service level packages.

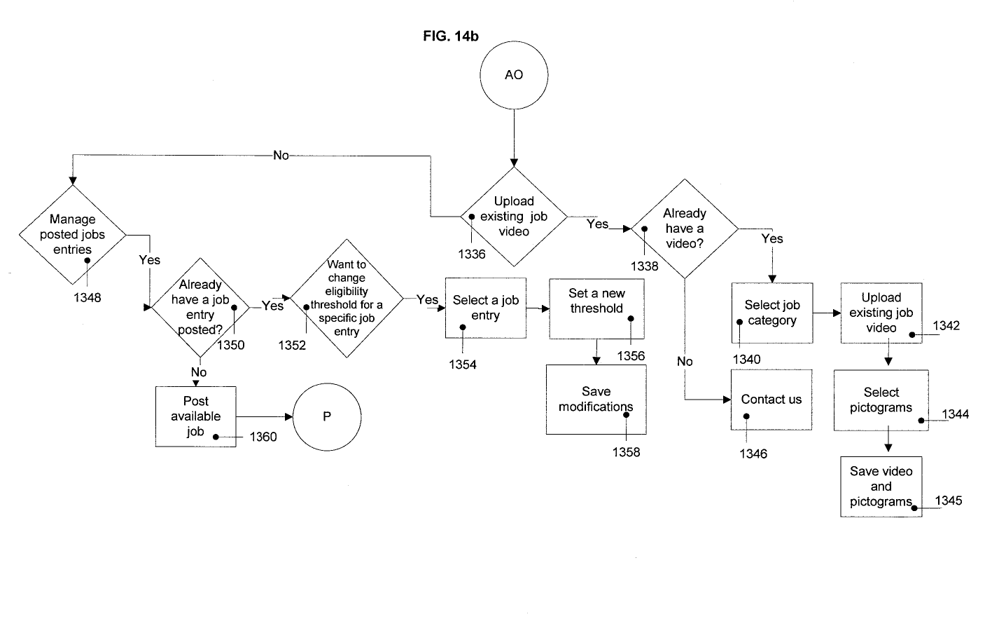

Referring to FIGS. 9 and 14, there are presented block flowcharts showing exemplary processes performed by a user of the website of the system 30. At step 726, the system will direct the user, who is an organization, to its member profile (step 1300). At step 1302, the user may choose to manage its profile and if the user is accessing its profile for the first time (step 1304), the system will prompt the user to set up his profile (step 1306) by completing an online form (step 1308). The user may save the information entered on the form at step 1310.

If the user's profile has been previously set up (step 1304), the user may modify its account and its information via its profile (step 1312). At step 1312, the user may modify its subscription by proceeding to step 1314 to select a new service level package. At step 1314, the system will redirect the user to step 712 and the user may proceed therefrom as described above.

At step 1312, if the user does not choose to modify its subscription, it may proceed to step 1316, where it may modify its profile. The user may change any information in its profile (step 1318) and save the changes (step 1320). The user may also choose to upload a video clip about the organization itself (step 1322). If the user already has a video clip in a format that is compatible with the system (step 1324), it may select the import video tool available in its profile (step 1326) and then the user will be prompted to select the video file it wishes to upload from its computer system (step 1328). Once the user has selected a video file to upload, it has the option of making the video file accessible from the job entry page of every job posted by the user (step 1330). Once the video is uploaded, the user may proceed step 1334 to save the changes. However, if the user does not have a video clip prepared or its video clip is not in an appropriate format (step 1324), it may contact the administrator for assistance in creating or converting a video clip (step 1332).

From step 1336, the user may choose to upload a video for an existing job in the organization (“existing job video”). If the user already has a video file, and its format is acceptable by the system (step 1338), it may select the job category (e.g. full-time, part-time, or the like) that the existing job video is related to from a list of categories or enter a category if the appropriate job category is not listed (step 1340). Once the user has selected a job category, he may proceed to step 1342 to upload the existing job video clip. After the video clip is uploaded, the system will provide the user a preset list of pictograms from which the user may select the pictograms that will be associated with the particular existing job video clip (step 1344). After selecting the pictograms, the system will prompt the user to enter information associated with each pictogram. As discussed above, the system may generate customized reports based on the pictogram information provided by the corresponding employer organizations. At step 1345, the user may proceed to save the existing job video and the associated pictogram information. However, if the user does not have a video clip prepared or its video clip is not in an appropriate format (step 1338), it may contact the administrator for assistance in creating or converting a video clip (step 1346).

At step 1348, the user may choose to manage its job postings by either modifying current job entries (step 1350) or by adding a new job entry (step 1360). If the user has already posted job entries (step 1350), it may choose to change the information related to a particular job entry, such as the eligibility threshold (step 1352). At step 1354, the user may select a job entry and proceed to modify eligibility threshold of the questionnaire associated with the selected job entry (step 1356). After modifying a job entry, the user may save the modifications at step 1358.

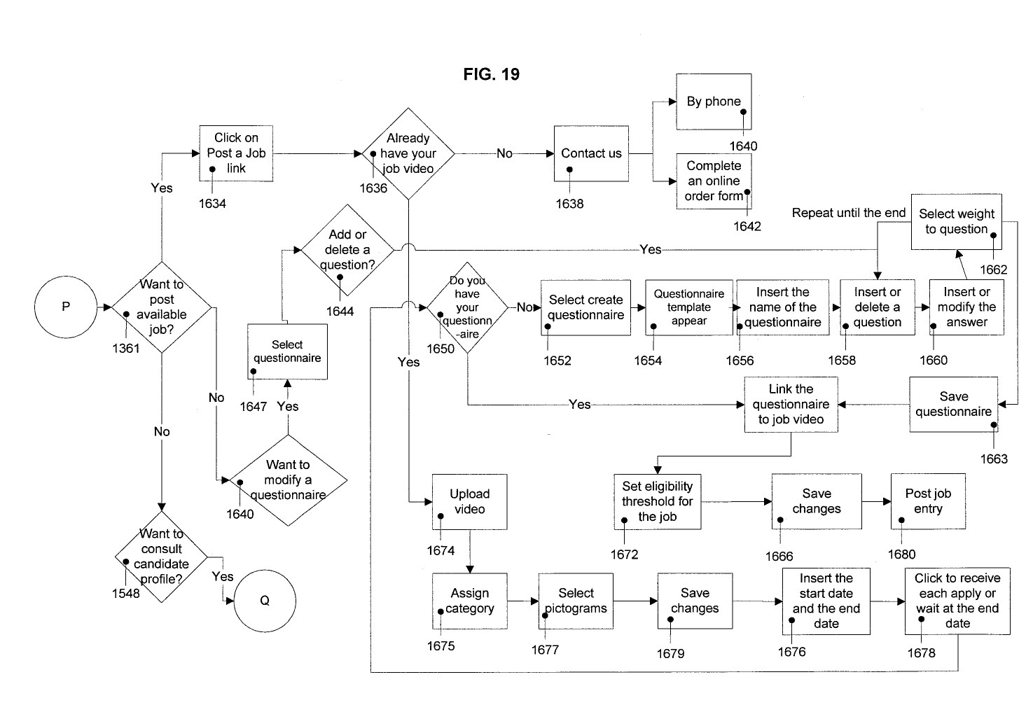

Referring to FIGS. 14 and 19, there are presented block flow charts showing exemplary processes performed by a user of the website of the system. At step 1360, the user, who is an organization member, may post an available job by adding a job entry to the system. At step 1361, the user may choose to add a job entry by selecting the link for posting a job (step 1634). If the user does not already have a video clip prepared for the available job or its video clip is not in an appropriate format (step 1636), it may contact the administrator for assistance in creating or converting a job video clip (step 1638) by telephone (step 1640) or by completing an online order form (step 1642). If the user already has a job video file that is compatible with the system (step 1636), the user may proceed to locate and select the file from its computer system or from its list of saved existing job videos in its profile, and upload the video file (step 1674). Once the video file is uploaded, the user may assign a job category to the available job that corresponds to the video (step 1675) and may then proceed to select pictograms that will be associated with the available job (step 1677). After selecting the pictograms, the system will prompt the user to enter information associated with each pictogram. At step 1679, the user may proceed to save the video and the associated pictogram information. The system will then prompt the user at step 1676 to enter a start date when job seekers may begin viewing the corresponding job entry page and an end date when the job entry page will no longer be accessible to job seekers. At step 1678, the user may select the frequency at which it is to receive notification regarding applications to the job entry. For example, the user may choose to receive an instant notification as each application is submitted or to receive a single notification of all the submitted applications at the expiration of the job entry posting (i.e. the end date).

After the user has entered the settings at steps 1676 and 1678, the system will prompt the user to upload a questionnaire for the job (step 1650). If the user does not have a prepared questionnaire, it may proceed to create a questionnaire at step 1652 and the system will generate a questionnaire template for the user to populate with questions (step 1654). Before adding questions to the template, the system will prompt the user to enter a name and a reference number for the questionnaire (step 1656) so that the user may later retrieve the same questionnaire. From step 1656, the user may add a question on to the template (step 1658). At steps 1660 and 1662, respectively, the user may insert the correct answer, i.e. yes or no, or true or false, that corresponds to the question, and assign a weight to the question. The weight may be selected from a preset list presented to the user in the form of a scroll box or selectively chosen by the user. The user may repeat steps 1658, 1660 and 1662 to populate the questionnaire template with the desired number of questions. After the questionnaire is completed and saved (step 1663), the use choose to link the questionnaire with the uploaded video clip (step 1664). After linking the questionnaire with the job video, the user may proceed to set the eligibility threshold for the job (step 1672), save the changes (step 1666), and then post the job entry (step 1680).

At step 1650, if the user already has a previously prepared questionnaire, it may proceed to link the questionnaire with the uploaded job video (step 1664). After linking the questionnaire with the job video, the user may proceed to set the eligibility threshold for the job (step 1672), save the changes (step 1666), and then post the job entry (step 1680).

At step 1361, the user may choose to modify a questionnaire that was previously prepared and saved to the system (step 1640), as described above in accordance with steps 1650 to 1666. From step 1640, the user may select a questionnaire to modify at step 1647 from a list of saved questionnaires in its profile. The user may also recall a questionnaire by its name and/or reference number. At step 1644, the user may add, delete or modify the questions of the selected questionnaire by following steps 1658 to 1662, as discussed above, and proceed to save the modified questionnaire at step 1663.

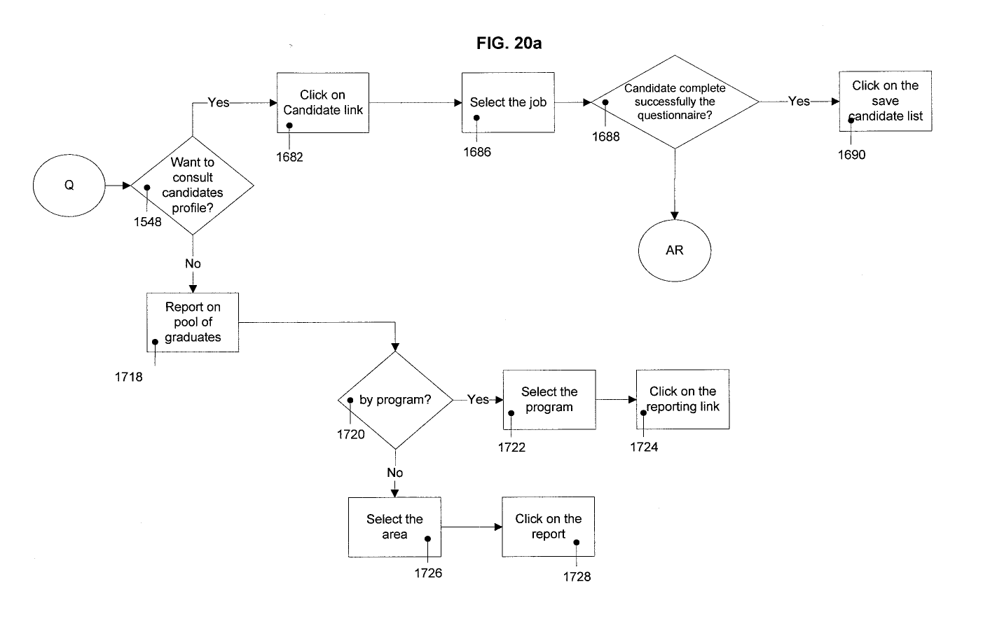

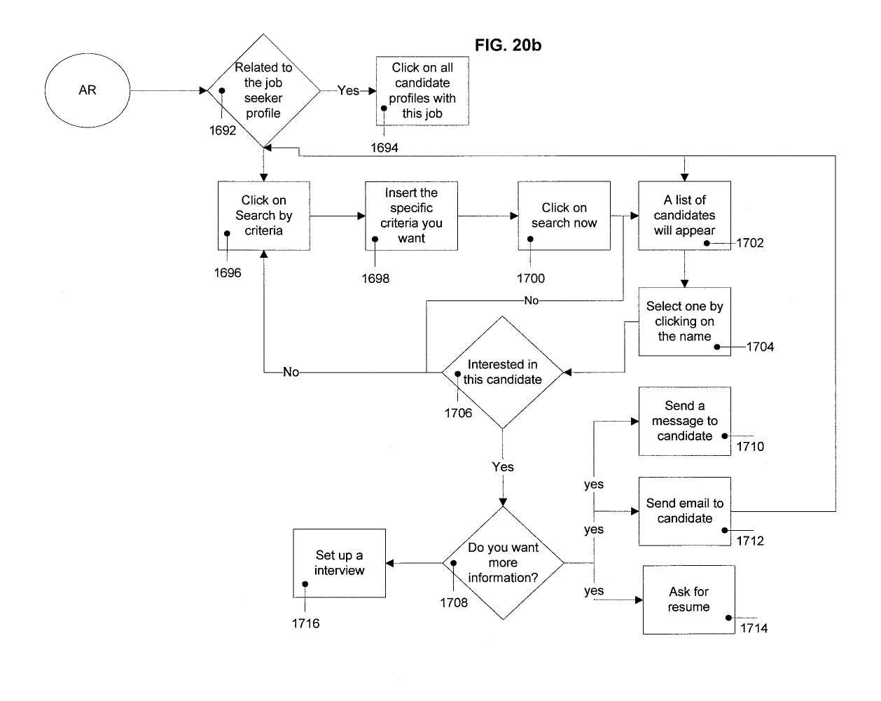

Referring to FIGS. 19 and 20, there are presented block flowcharts showing exemplary processes performed by a user of the website of the system 30. Here, the user is an organization member. At step 1548, the user may choose to consult candidate profiles by selecting the corresponding link (step 1682). Once the user selects the link (step 1682), the system will direct the user to step 1686 wherein it may select a job from a list of jobs posted by the user. If there are job seekers who already completed the questionnaire associated with the selected job and whose eligibility score meets the eligibility threshold set by the user (step 1688), the user may choose to view and save the list of eligible job seekers (step 1690). The identity of the eligible job seekers may be disguised by identifying each job seeker using an ID code or number, instead of the job seeker's actual name. At step 1692, the user may view and save a list of job seekers who has saved the selected job entry in their corresponding profiles (step 1694). The user may also conduct a search of all job seekers who has saved the selected job entry (step 1696) by entering specific search criteria at step 1698, such as preferences, education level, type of degree or diploma, institution that issued the degree or diploma, geographical location of residence, or the like. Once the user confirms the search criteria (step 1700), the system will perform the search and return a list of job seekers who meet the search criteria (step 1702). The user may view information about a particular job seeker by selecting the corresponding username from the list (step 1704) and if the user is interested in the selected job seeker (step 1706), the user may proceed to request more information about the job seeker (step 1708) by sending the job seeker an electronic message to his profile page or mobile device (step 1710), by sending an email to the job seeker (step 1712), or by sending a request to the job seeker for a copy of his resume (step 1714). At step 1708, the user may also choose to set up an interview with the selected job seeker (step 1716). After requesting more information (steps 1710, 1712, 1714) or setting up an interview (step 1716), the user may return to the list of search results (step 1702) or start a new search (step 1696). At step 1706, if the user is not interested in the selected job seeker after viewing his information, the user may return to the list of results (step 1702) or start a new search (step 1696).

At step 1548, the user may proceed to request a report on the pool of past and future graduates of a particular program, area of study, or by institution (step 1718). If the user wishes to search by program (step 1720), the user may select a program from a preset list (step 1722) and select the reporting link (step 1724). The system will then generate a report based on education information provided by institutions. The report will include a list of job seekers who have completed the selected program and/or a list of future graduates of the selected program. The report may be sent to the user's profile or to the user's email account.

The user may also conduct a search by selecting an area of study from a preset list (step 1726) and select the reporting link (step 1728). The report generated from this type of search is also based on the education information provided by institutions.

Referring to FIGS. 6b and 19, there are presented block flowcharts showing exemplary processes performed by a user of the website of the system 30. Here, the user is a partner, an institution, or an employer organization. At step 491, if the user wants to post a job video, the system will ask the user to confirm that it is a member (step 820). If the user enters its user ID and the correct password, the system will direct the user to step 1360 and the user may post a job video as described above.

Referring to FIGS. 6b and 20, there are presented block flowcharts showing exemplary processes performed by a user of the website of the system 30. Here, the user is a partner, an institution, or an employer organization. At step 491, if the user wants to search the system's database of job seekers, the system will ask the user to confirm that it is a member (step 822) by requesting the user to enter its user ID and password. Once the user confirms that it is a member, the system will direct the user to step 1548 and the user may proceed to search the system's database of job seekers as described above.

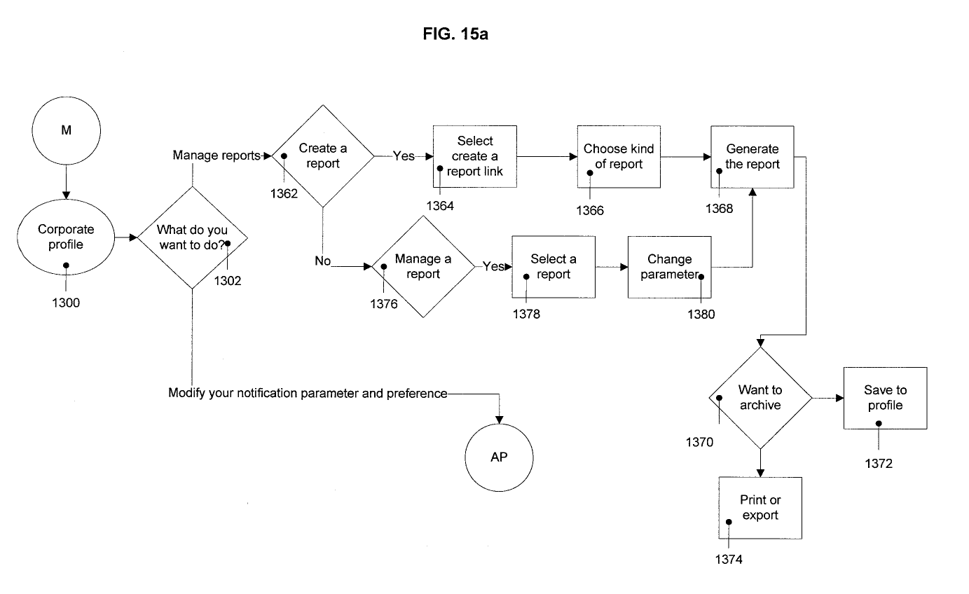

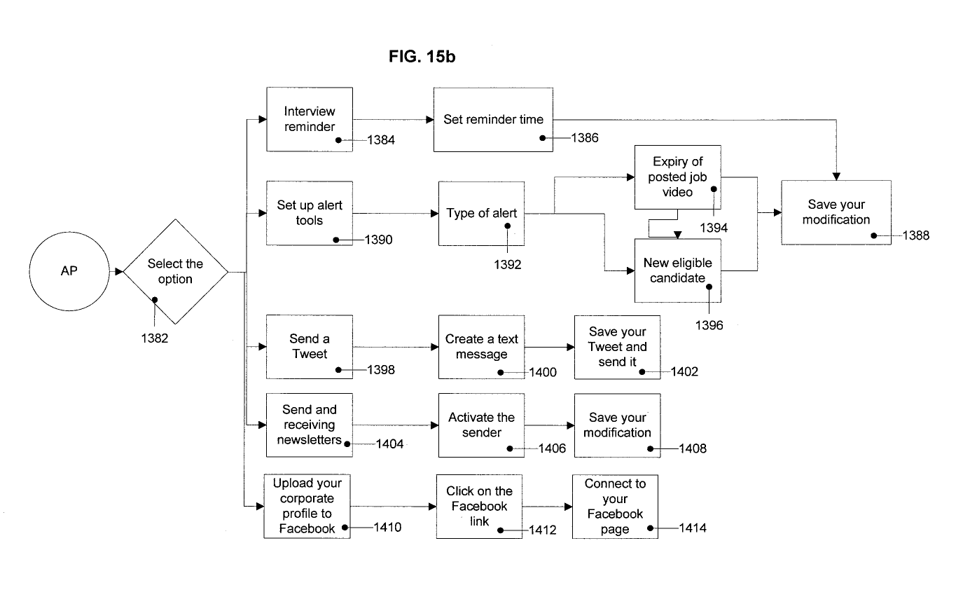

Referring to FIG. 15, there is presented a block flowchart showing exemplary processes performed by a user of the website of the system 30. Here, the user is an organization. On the user's profile page (step 1300), the user may select from a number of options (step 1302) including requesting and managing reports (step 1362) and modifying notification parameters and preferences (step 1382).

At step 1362, if the user chooses to request a report by selecting the corresponding link (step 1364), the system will direct the user to step 1366, where the user may request a specific type of report by making a selection from a preset list, or by contacting the administrator. After making the selection, the system generates a report based on the type of information requested by the user and the relevant data from the database (step 1368). The report is then sent electronically to the user's account. At step 1370, the user may choose to archive the report by saving the report to its profile (step 1372) or by printing or exporting the report (step 1374).

At step 1362, if the user chooses to manage an existing report (step 1376), it may proceed to step 1378 where it may select a previously generated report that was saved in its profile or in its computer system. Once a report is selected, the user may change any of the search parameters of the report (step 1380), either through the user interface or by contacting the administrator, and the system will generate a new report based on the modified parameters (step 1368). Likewise, the report is sent to the user's profile, where it may choose to archive the report (step 1370) by saving the report to its profile (step 1372) or by printing or exporting the report (step 1374).

At step 1382, the user has a number of options including interview reminder (step 1384), alert tools (step 1390), send a Tweet™ communication (step 1398), send and receive newsletters (step 1404), and upload profile (step 1410). At step 1384, the user may set up an electronic reminder for an upcoming interview by selecting how far in advance it would like to receive the reminder (step 1386). The reminder may be in the form of an email, a text message, an alert in the user profile, or the like, depending on the user's preset preferences. After setting an interview reminder, the user may proceed to step 1388 to save the changes.

At step 1390, the user may set up alert tools for his account by selecting the type of alert (e.g. email, text message, alert in profile, or the like) at step 1392, and the type of alert may be specific to each type of event . For example, the user may select the type of alert it would like to receive in the event that a job entry posted by the user is about to expire (step 1394), or in the event that a job seeker's eligibility score meets the preset eligibility threshold set by the user for the corresponding job entry (step 1396). Any alert tool modifications made by the user may be saved at step 1388.

At step 1398, the user may send a Tweet™ communication by first creating a text message (step 1400) and then saving and sending the message to the Twitter™ service (step 1408). At step 1404, the user may set up its newsletter option. The user may choose to receive newsletters from certain entities by selecting those entities from a list of newsletter publishers at step 1406, and proceed to save the selections at step 1408. At step 1410, the user may upload its profile to a social networking site, such as the Facebook™ site by selecting the corresponding link (step 1412) and logging on to the user's profile page on the selected networking site (step 1414).

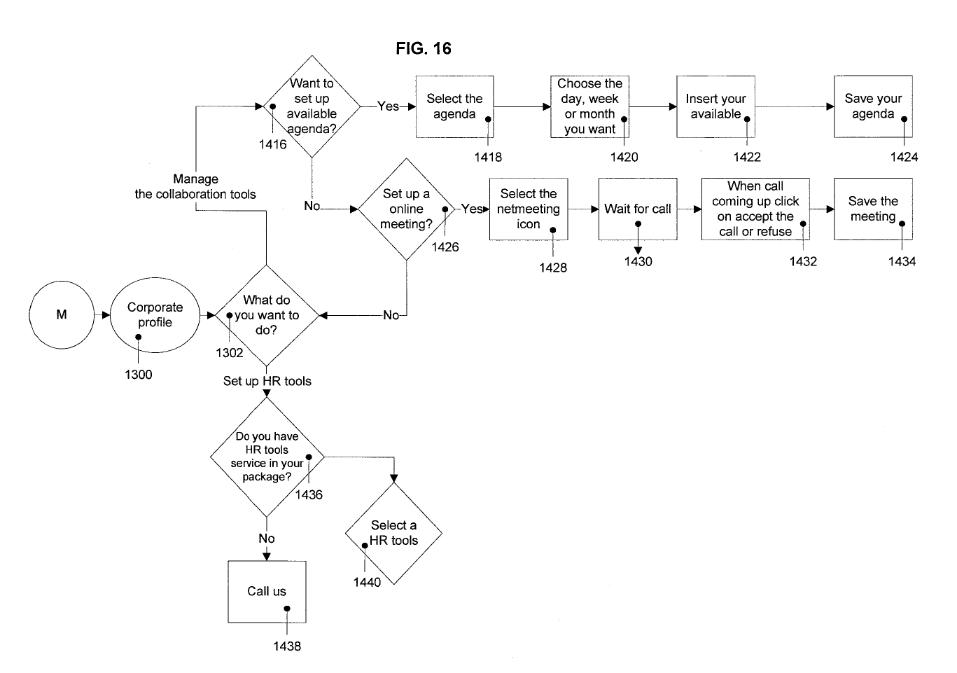

Referring to FIG. 16, there is presented a block flowchart showing exemplary processes performed by a user of the website of the system 30. Here, the user is an organization. At step 1302, the user is presented with a number of options, including managing collaboration tools and setting up human resources tools. If the user chooses to manage collaboration tools at step 1302, the user may proceed to set up its agenda (step 1416) by selecting the corresponding link (step 1418). At step 1420, the user is presented with an electronic calendar where it may select dates and times and indicate its availability for interviewing job candidates for the selected time slots (step 1422). The modified agenda may be saved at step 1424.

At step 1426, the user may choose to set up an online meeting by selecting the corresponding icon (step 1428). At step 1430, the user is standing by for a call and when the call comes in, the user may accept or ignore the call (step 1432). The user may further proceed to step 1434 to save the call.

If the user chooses to set up human resources tools at step 1302, it may proceed to step 1436, where the system will check whether these tools are included in the user's service package. If the user's service package does not include these tools, the system will prompt the user to contact the administrator to upgrade its service package (step 1438). If the user's service package does include access to human resources tools, the system will direct the user to step 1440, where the user may select from a number of electronic human resources tools that are provided by partner members to assist the user in managing the user's employees and personnel.

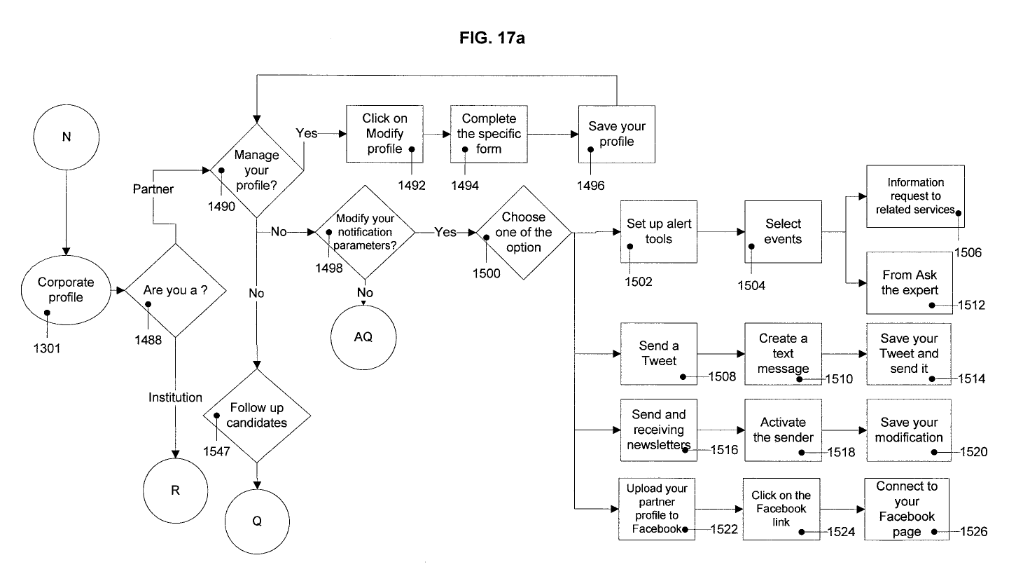

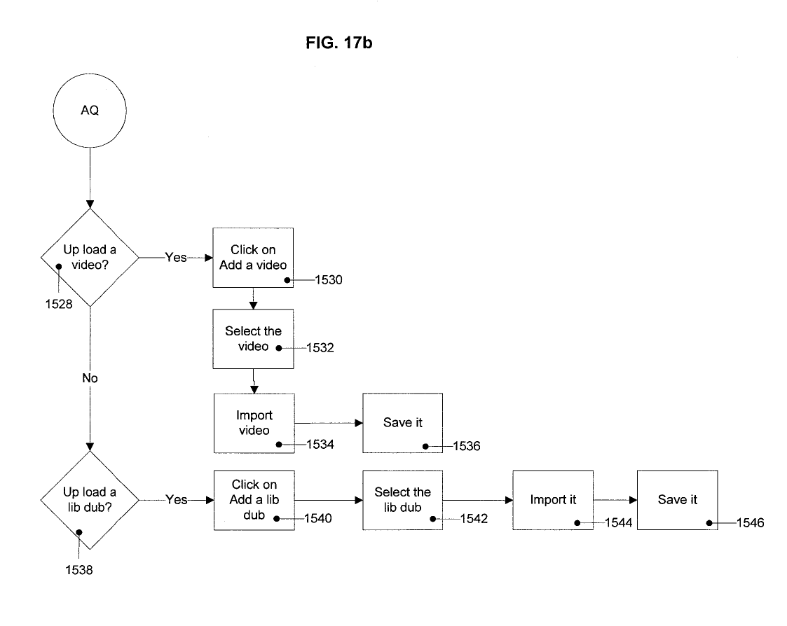

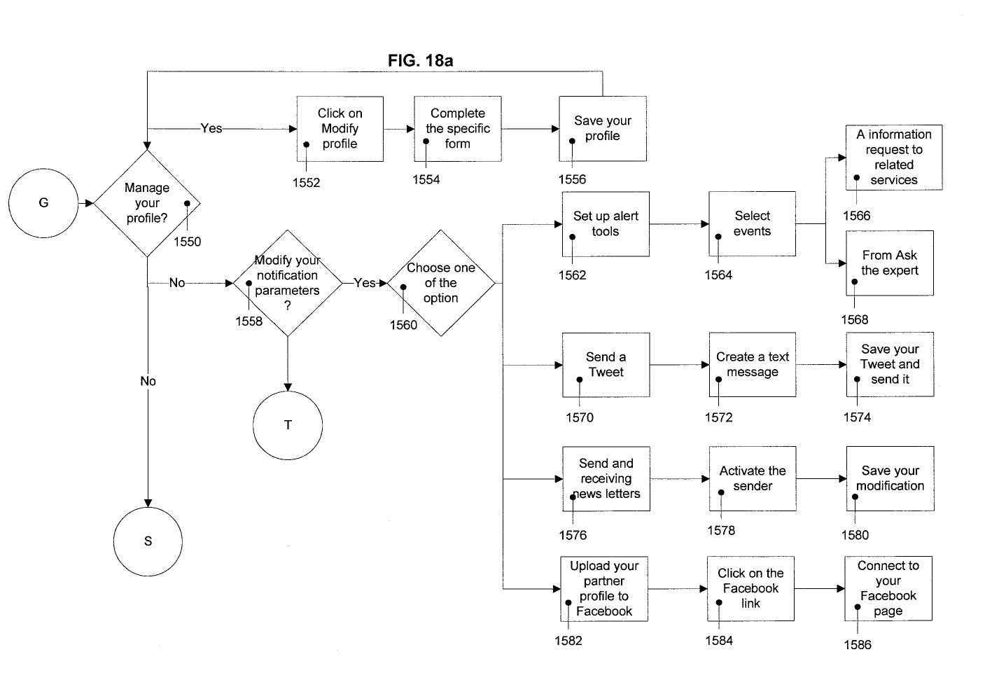

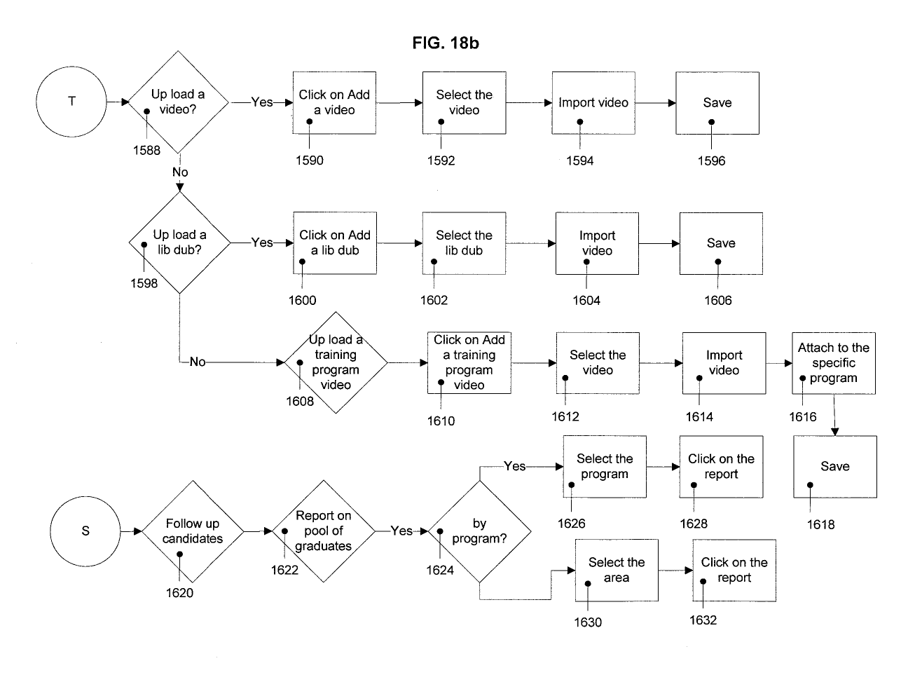

Referring to FIGS. 17, 18a, 18b and 20, there are presented block flowcharts showing exemplary processes performed by a user of the website of the system 30. Here, the user is either a partner or an institution. At the profile page (step 1301), if the user is a partner (step 1488), the system will direct the user to step 1490, where the user may proceed to manage its profile by selecting the corresponding link (step 1492). The user may then edit its profile information presented in the form of an online form (step 1494) and save the modifications at step 1496. From step 1496, the user may return to step 1490 or exit its profile. At step 1490, if the user instead chooses to modify its notification parameters, it may proceed to step 1498 and select one of many options (step 1500), including set up alert tools (step 1502), send a Tweet™ communication (step 1508), send and receive newsletters (step 1516) and upload profile (step 1522).

If the user chooses to set up alert tools (step 1502), it may proceed to step 1504 to select from a preset list the types of events for which to receive alerts and also the specific type of alert (e.g. email, text message, message to profile, or the like) to receive for each type of event. For example, the user may choose to receive an alert for any information requests sent by other members to the user's account regarding the user's services (step 1506) and the alert may be in the form of an email, text message, or a profile message, depending on the user's preferences. Likewise, the user may choose to receive alerts for questions posted by members that are related to the user's area of expertise or services (step 1512).

At step 1500, the user may proceed to step 1508 to send a Tweet™ communication. The user may create a text message at step 1510 and then proceed to save and send the message through the Twitter™ service (step 1514).

At step 1516, the user may set up its newsletter option. The user may choose to receive newsletters from certain entities by selecting those entities from a list of newsletter publishers at step 1518, and proceed to save the selections at step 1520. At step 1500, the user may proceed to step 1522 to upload its profile to a social networking site, such as the Facebook™ site, by selecting the corresponding link (step 1524) and logging on to the user's profile page on the selected networking site (step 1526).

At step 1498, if the user does not choose to modify its notification parameters, it may proceed to step 1528 to upload a video clip. The user may select the link for uploading a video clip (step 1530) and then select a video clip from its computer system to upload (step 1532). Once the user has selected a video clip, the system will import the video clip to the user's profile (step 1534) and then the user may proceed to save this modification at step 1536.

At step 1528, if the user does not choose to upload a video clip, the user may proceed to step 1538 to upload a lib dub video. The user may select the link for uploading a lib dub (step 1540) and then select the lib dub to be uploaded from its computer system (step 1542). Once the user has selected a lib dub, the system will import the video clip to the user's profile (step 1544) and the user may proceed to save this change at step 1546.

At step 1490, the user may select the follow up candidate option (step 1547) and the system will redirect the user to step 1548. From step 1548, the user may proceed as described in detail above.

At step 1488, if the user is an institution, the system will direct the user to step 1550. At step 1550, the user may proceed to manage its profile by selecting the corresponding link (step 1552). The user may then edit its profile information presented in the form of an online form (step 1554) and save the modifications at step 1556. From step 1556, the user may return to step 1550 or exit its profile. At step 1550, if the user instead chooses to modify its notification parameters, it may proceed to step 1558 and select one of many options (step 1560), including set up alert tools (step 1562), send a Tweet™ communication (step 1570), send and receive newsletters (step 1576) and upload profile (step 1582).

If the user chooses to set up alert tools (step 1562), it may proceed to step 1564 to select from a preset list the types of events for which to receive alerts and also the specific type of alert (e.g. email, text message, message to profile, or the like) to receive for each type of event. For example, the user may choose to receive an alert for any information requests sent by other members to the user's account regarding the user's services (step 1566) and the alert may be in the form of an email, text message, or a profile message, depending on the user's preferences. Likewise, the user may choose to receive alerts for questions posted by members that are related to the user's area of expertise or services (step 1568).

At step 1560, the user may proceed to step 1570 to send a Tweet™ communication. The user may create a text message at step 1572 and then proceed to save and send the message through the Twitter™ service (step 1574).

At step 1576, the user may set up its newsletter option. The user may choose to receive newsletters from certain entities by selecting those entities from a list of newsletter publishers at step 1578, and proceed to save the selections at step 1580. At step 1560, the user may proceed to step 1582 to upload its profile to a social networking site, such as Facebook™ by selecting the corresponding link (step 1584) and logging on to the user's profile page on the selected networking site (step 1586).

At step 1558, if the user does not choose to modify its notification parameters, it may proceed to step 1588 to upload a video clip. The user may select the link for uploading a video clip (step 1590) and then select a video clip from its computer system to upload (step 1592). Once the user has selected a video clip, the system will import the video clip to the user's profile (step 1594) and then the user may proceed to save this modification at step 1596.

At step 1588, if the user does not choose to upload a video clip, the user may proceed to step 1598 to upload a “lib dub”. The user may select the link for uploading a lib dub (step 1600) and then select the lib dub to be uploaded from its computer system (step 1602). Once the user has selected a lib dub, the system will import the video clip to the user's profile (step 1604) and the user may proceed to save this change at step 1606.

At step 1598, if the user does not choose to upload a lib dub, the user may proceed to step 1608, to upload a training program video. The user may select the link for uploading a training program video (step 1610) and then select a video clip from its computer system to upload (step 1612). Once the user has selected a video clip, the system will import the video to the user's profile (step 1614). The user may link the video clip to a corresponding program by selecting the program from a list provided by the system (step 1616) and proceed to step 1618 to save the changes.

From step 1550, the user may select the follow up candidate option (step 1620) and the system will direct the user to step 1622, where the user may request a report on past and future graduates. If the user wishes to search by program (step 1624), the user may select a program from a preset list (step 1626) and select the reporting link (step 1628). The system will then generate a report based on education information provided by institutions. The report will include a list of job seekers who have completed the selected program and/or a list of future graduates of the program. The report may be sent to the user's profile or to the user's email account. The user may also conduct a search by selecting an area of study from a preset list (step 1630) and select the reporting link (step 1632). The report generated from this type of search is also based on the education information provided by institutions.

Reference is now made to FIGS. 21 to 38 where a number of user screens are depicted showing various user interfaces which may be used in conjunction with some embodiments of the present invention. FIG. 21 is an exemplary website homepage 2000 of the system 30 for a particular user and includes a navigation panel 2002 presenting navigation options. The navigation options include membership 2004, jobs available 2006, jobs encyclopaedia 2008, organizations encyclopaedia 2010, organizations services 2012, and directory of professional development program (“DPDP”) 2014. The homepage 2000 may also includes a service panel 2018, where the user may select the language in which to view the website, and may access the contact information and profile information of the system host. The homepage 2000 may provide a search window 2020 through which the user may perform a search of jobs directly from the homepage 2000, and the search may be performed by keywords and/or selecting criteria listed in window 2020. An area 2016 displaying illustrative images of most-viewed job video clips and organization videos may also be provided on the homepage 2000. The homepage 2000 may include a jobs panel 2021 and an organization panel 2013 to feature randomly selected job entries and employer organizations, respectively, that are in the system's database. The featured jobs and organizations may be different each time the homepage 2000 is loaded or refreshed. On the homepage 2000, a login area may be provided 2023 where a member may enter his username and password to login to his profile page that is associated with his member account. The homepage 2000 may also include a link or an icon 2022 that provides a shortcut for the member to access his profile page from the homepage 2000.

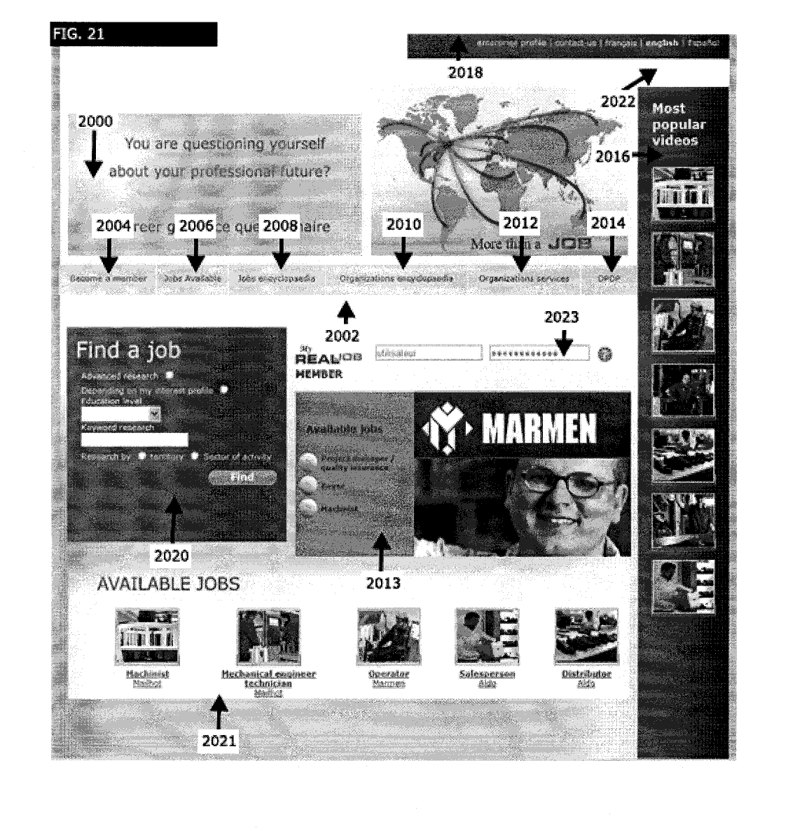

FIG. 22 is an exemplary screen display of a user interface depicting an example member profile page 2025 for a particular member of the system 30. The member profile page 2025 includes a profile panel 2026 presenting profile options, which may include updating resume, job search, job alert, pension revenue calculator, and alert settings. The profile page 2025 may provide a member information area 2028 where general information about the member, such as home address, telephone number, email address, or the like, is displayed. On the profile page 2025, there may also be a communication tools panel 2034 presenting communication options to the member, which may include links to social networking sites such as those marked and known by the trade-marks Facebook™, Del.icio.us™, Reddit™, and Digg™, and online communication tools such as email, live chat, and the NetMeeting™ application. The profile page 2025 may also provide a new videos area 2036 where illustrative images of job video clips of recently posted job entries are featured. The featured job entries may be selected randomly or based on the particular member's preferences. A recent-viewed video area 2038 may be provided on the profile page 2025 to display the illustrative images of job video clips that the member had recently accessed. The profile page 2025 may further include an update display 2032 which provides the member of his recent activities and/or upcoming events, and a video output display 2030 for video conferencing. A link 2042 to the homepage 2000 and an advertisement area 2044 may also be included on the profile page 2025. An available jobs link 2040 may be provided near the advertisement area 2044, such that the member, by selecting link 2040, may view a list of available jobs being offered by the advertisement entity.

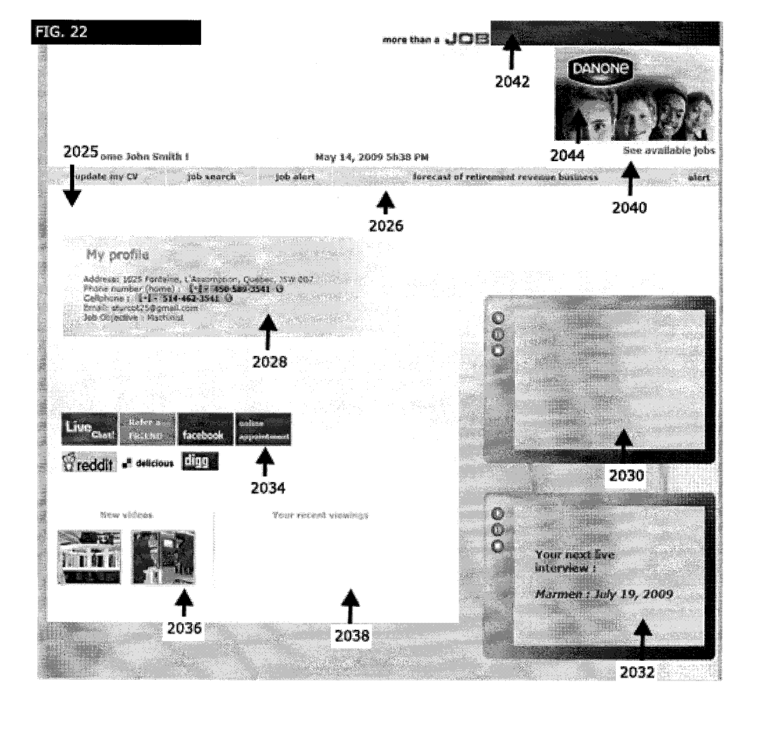

FIG. 23 is an exemplary screen display of a user interface depicting an example search page 2050 for the jobs available search option, as describe above, for a particular user of the system 30. The search page 2050 includes a search window 2054 whereby the user may conduct a search of currently available jobs in the system's database by keywords or by selecting certain search criteria (e.g. employment type, job title, education level, or the like) from the preset lists provided in the search window 2054. The search page 2050 may include a graphical illustration 2056 depicting the different types of jobs. In one embodiment of the invention, the illustration 2056 is a wheel divided into multiple sections, and each section represents a type of employment (e.g. full-time, part-time, on-call work, self-employment, or the like). Each section may also include the percentage of that particular type of job out of all the available jobs that are on the system 30. By selecting a section of the illustration 2056, the user may view a list of available jobs under the corresponding job type of the selected section. The search page 2050 may include a link 2058 to the virtual job fair section of the website, as discussed in detail above. A navigation panel 2002, a service panel 2018, a most popular video area 2016, and a member profile link 2022, all as previously described, may also be provided on the search page 2050.

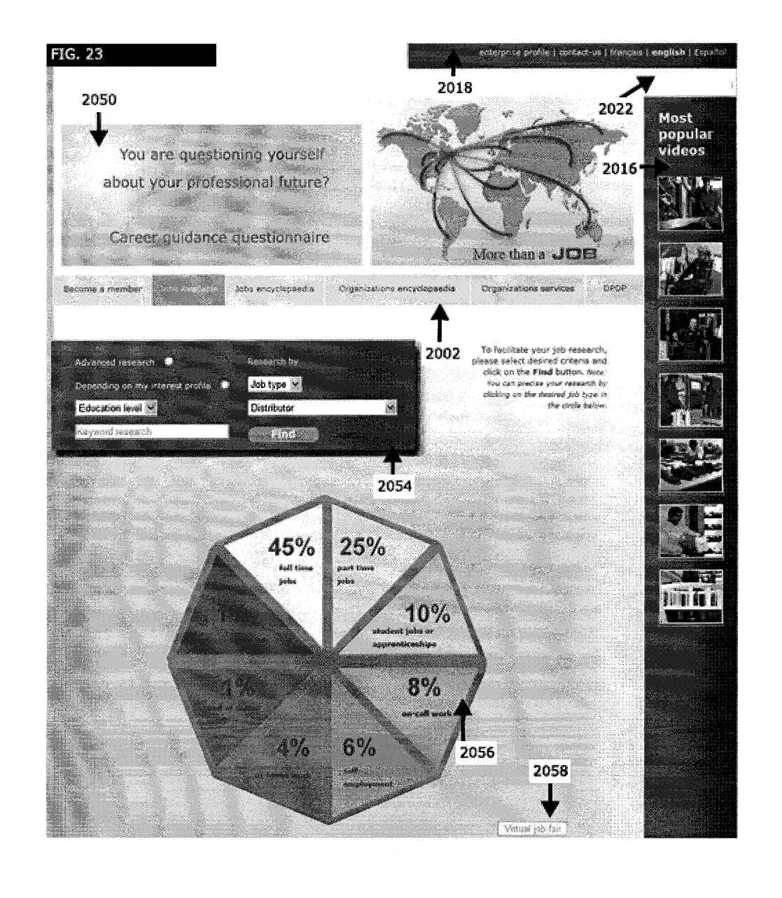

FIG. 24 is an exemplary screen display of a user interface depicting an example search results page 2060 generated by the system 30 from a search conducted under the jobs available search option for a particular user. The search results page 2060 includes a display area 2062 wherein illustrative images of the job entries that meet the user's search criteria or keywords are displayed. In addition to the illustrative images of job videos, the display area 2062 may also include basic information about the job entry that corresponds to each illustrative image, such as employer organization, job title, salary, education, and the number of times the job entry has been viewed, or the like. The search results page 2060 may also include a navigation panel 2002, a service panel 2018, a most popular video area 2016, a member profile link 2022, and a search window 2054, all as described in detail above.

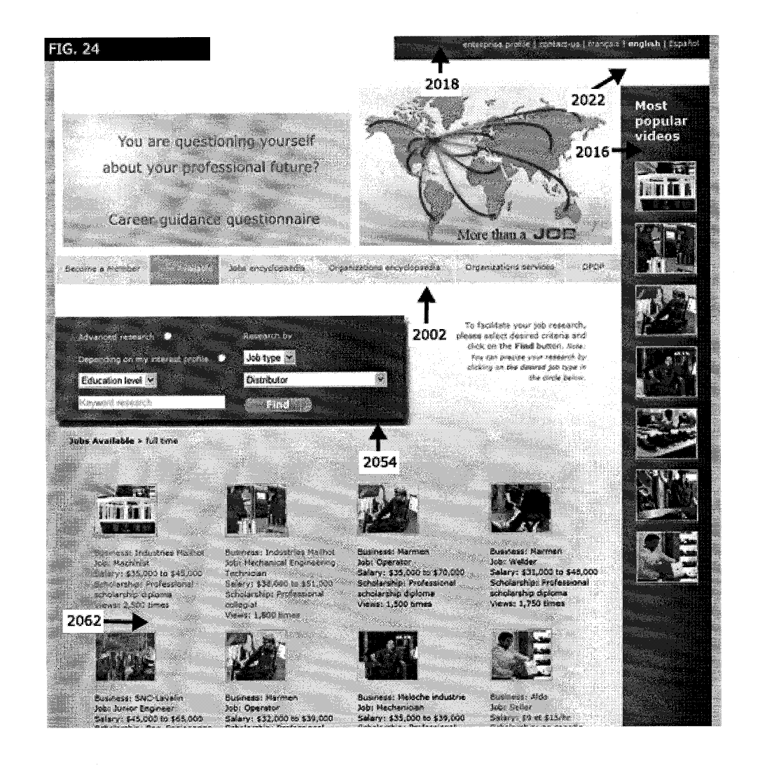

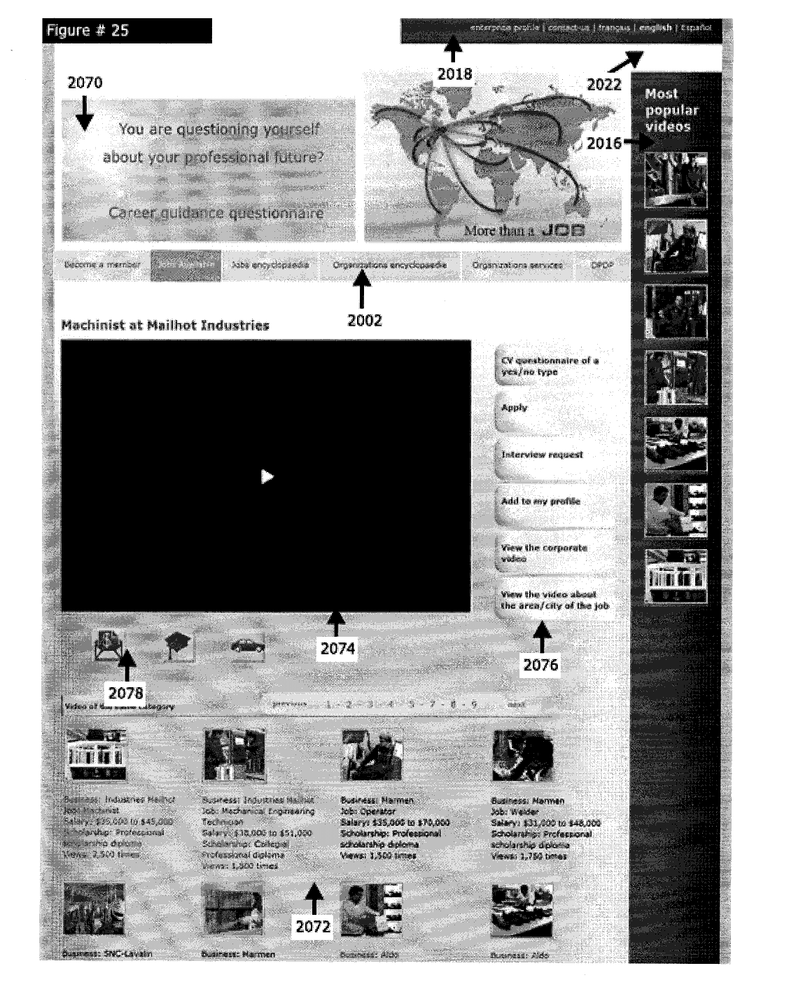

FIG. 25 is an exemplary screen display of a user interface depicting an example job entry page 2070 of the system 30 for a particular user. The job entry page 2070 includes a video viewing area 2074 where the user may view a video clip by selecting the area 2074. A pictogram loop 2078 and a job options menu 2076 may also be provided on the job entry page 2070. The pictogram loop 2078 comprises a predetermine number of pictograms, each providing supplementary information about the job entry, as described in detail above. On the job options menu 2076, the user may select an option by selecting the corresponding link or icon, and the options may include completing a questionnaire, applying for the job, requesting an interview, adding the job entry to profile, viewing the organization video, viewing the job city/area video, and viewing pre-selection tools and recommended training programs. The job entry page 2070 may include a related job entries listing 2072 that displays illustrative images of videos of job entries that have similar attributes as the current job entry. The user may view any one of the related job entries by selecting the corresponding illustrative image. The job entry page 2070 may also include a navigation panel 2002, a service panel 2018, a most popular video area 2016, and a member profile link 2022, all as described in detail above.

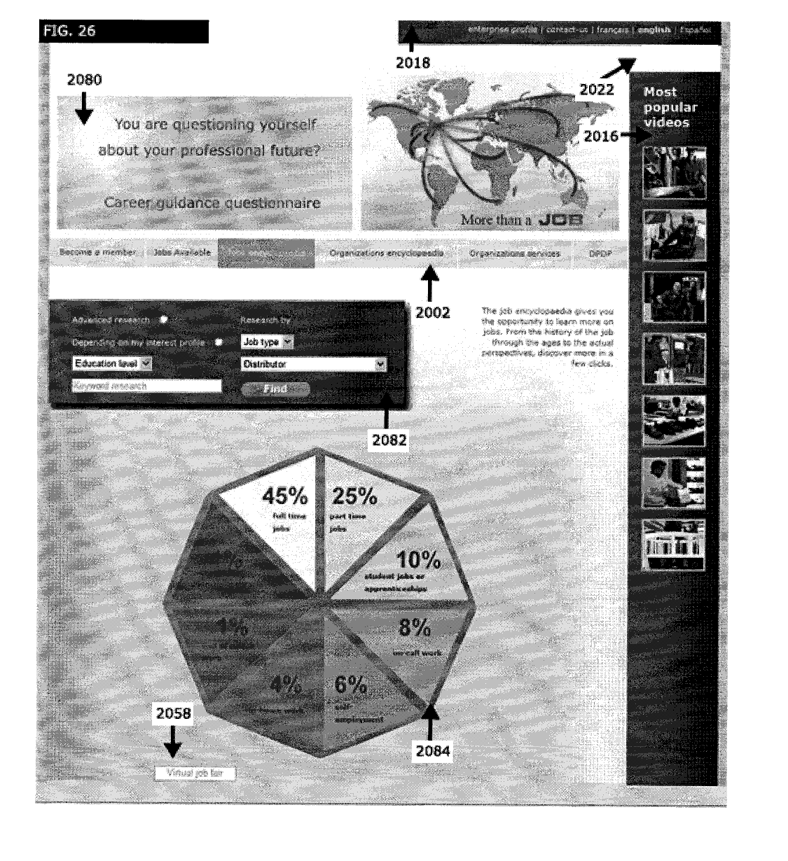

FIG. 26 is an exemplary screen display of a user interface depicting an example jobs encyclopaedia page 2080 for jobs of the present of the jobs encyclopaedia function, as describe above, for a particular user of the system 30. The jobs encyclopaedia page 2080 includes a search window 2082 whereby the user may conduct a search of the jobs of the present in the system's database by keywords or by selecting certain search criteria from the preset lists provided in the search window 2082. The jobs encyclopaedia page 2080 may include a graphical illustration 2084 depicting the different types of jobs. In one embodiment of the invention, the illustration 2084 is a wheel divided into multiple sections, and each section represents a type of employment (e.g. full-time, part-time, on-call, self-employment, or the like). Each section may also include the percentage of that particular type of job out of all the jobs that are on the system 30. By selecting a section of the illustration 2084, the user may view a list of jobs under the corresponding job type of the selected section. The jobs encyclopaedia page 2080 may include a link 2058 to the virtual job fair section of the website, as discussed in detail above. A navigation panel 2002, a service panel 2018, a most popular video area 2016, and a member profile link 2022, all as previously described, may also be provided on the jobs encyclopaedia page 2080.

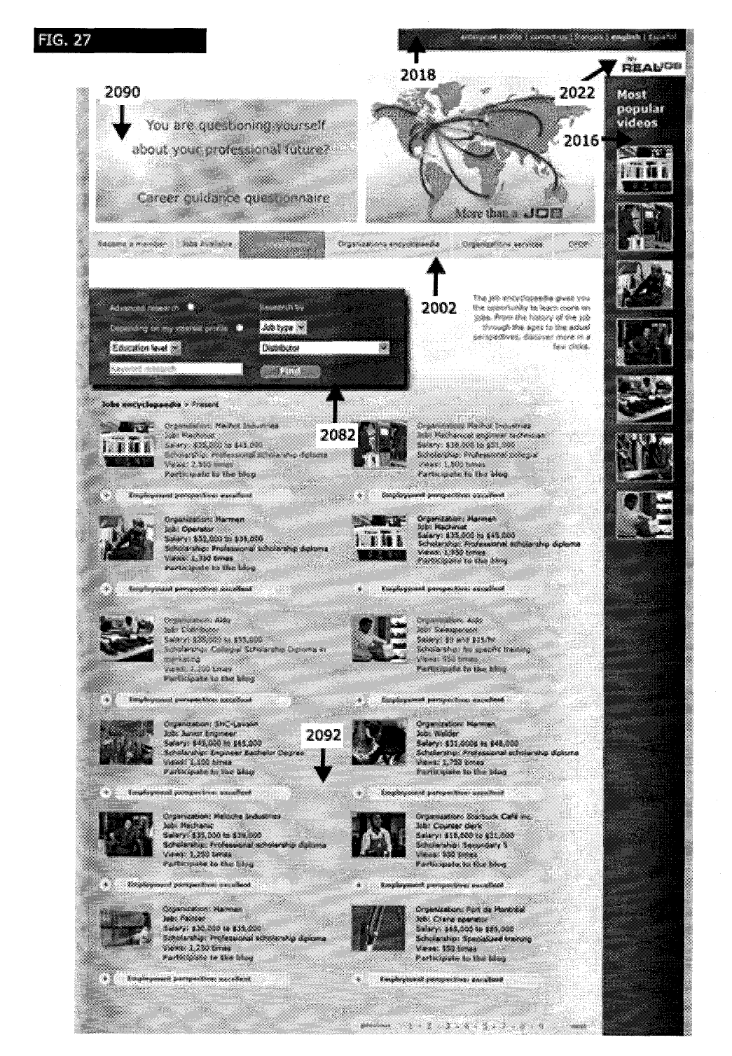

FIG. 27 is an exemplary screen display of a user interface depicting an example search results page 2090 generated by the system 30 from a search conducted under the jobs encyclopaedia search option for a particular user. The search results page 2090 includes a display area 2092 wherein illustrative images of videos of the job entries that meet the user's search criteria or keywords are displayed. In addition to the illustrative images of job videos, the display area 2092 may also include basic information about the job entry that corresponds to each illustrative image, such as employer organization, job title, salary, education, employment prospects, and the number of times the job entry has been viewed, or the like. For each illustrative image, the display area 2092 may further include a link to the corresponding job entry forum. The search results page 2090 may also include a navigation panel 2002, a service panel 2018, a most popular video area 2016, a member profile link 2022, and a search window 2082, all as described in detail above.

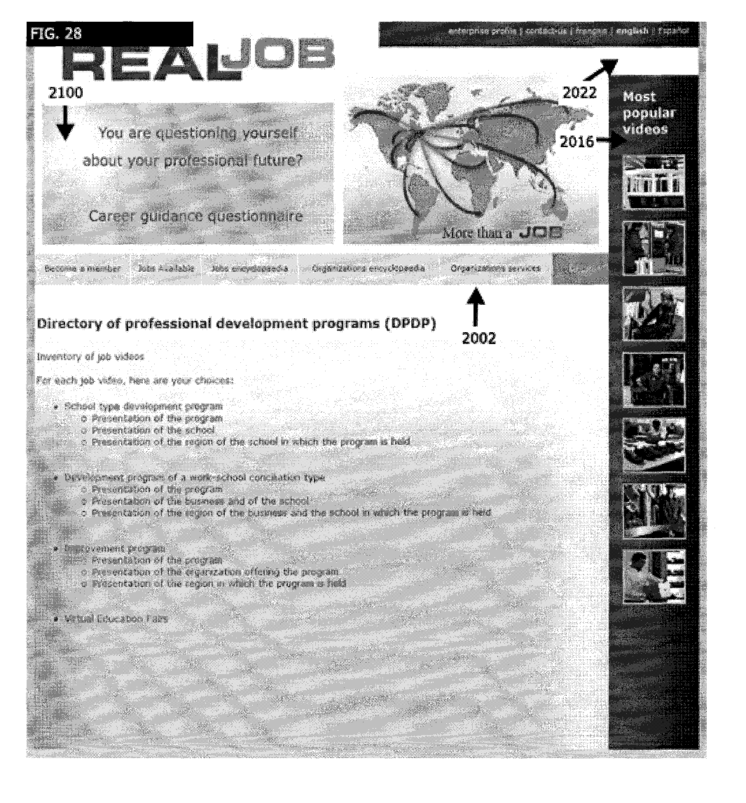

FIG. 28 is an exemplary screen display of a user interface depicting an example DPDP page 2100 of the system 30 for a particular user. The DPDP page 2100 may provide various links to information about institutions, partners, training programs, school programs, school and work conciliation programs, and educational fairs, as described in detail above. The DPDP page 2100 may also include a navigation panel 2002, a service panel 2018, a most popular video area 2016, and a member profile link 2022.

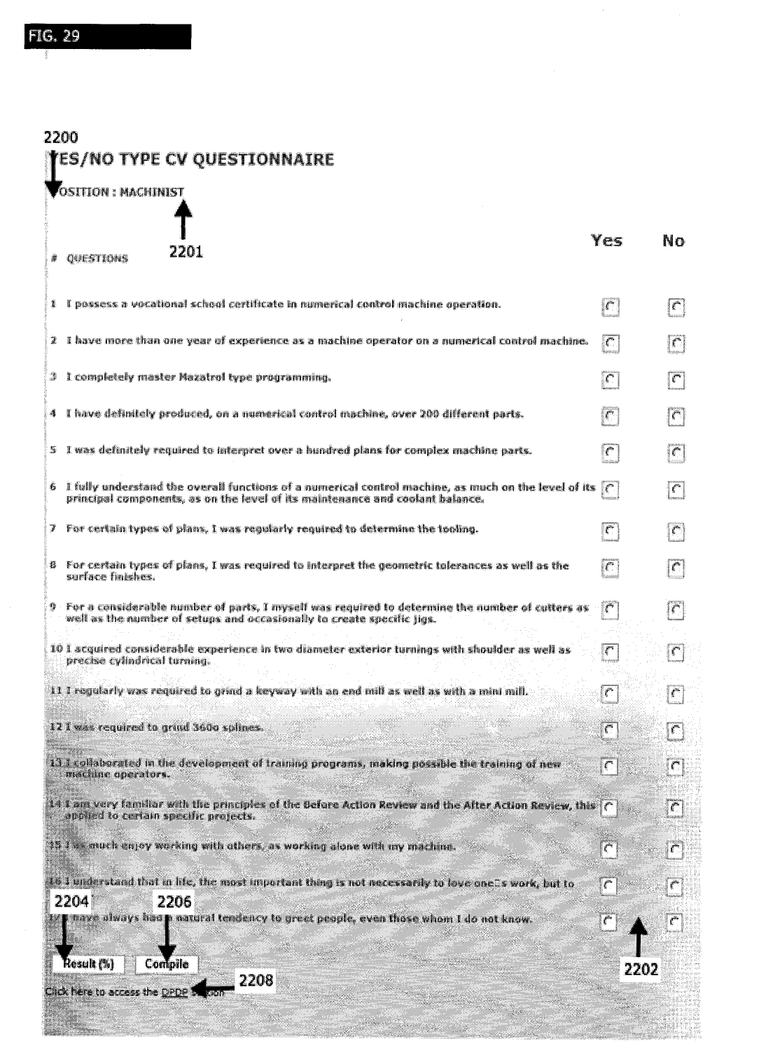

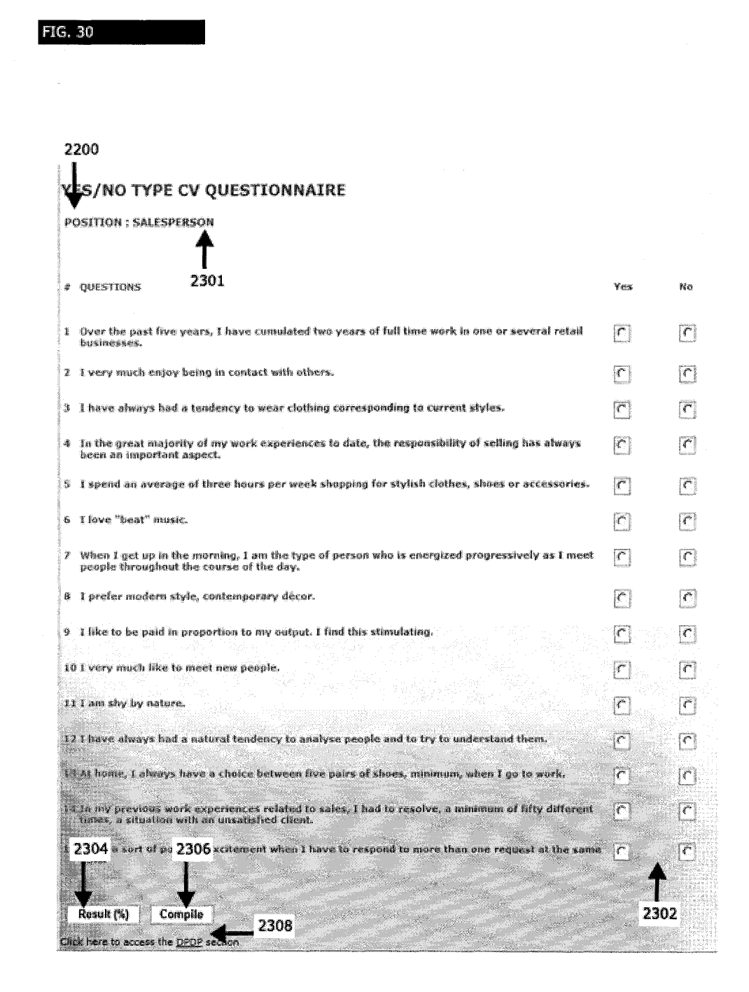

FIGS. 29 and 30 are exemplary screen displays of a user interface depicting example job entry questionnaire pages 2200 and 2300 of the system 30 for different jobs for a particular user. Job entry questionnaire pages 2200, 2300 include a questionnaire 2202, 2302 comprising a predetermined number of polar questions to which the user may answer yes or no (or true or false), as described above, and a title 2201, 2301 for the job position that corresponds to the questionnaire. The job entry questionnaire pages 2200, 2300 further include a result button 2204, 2304 an eligibility button 2206, 2306. When the user selects the result button 2204, 2304 after completing the questionnaire, the system 30 will generate an eligibility score based on the user's answers and the weight accorded to each answer as set by the corresponding employer organization, as described above. When the user selects the eligibility button 2206, 2306, the system will compare the user's eligibility score with the threshold preset by the organization and indicate to the user whether he is eligible for the job. The job entry questionnaire pages 2200, 2300 may also include a link 2208, 2308 to the above described DPDP page.

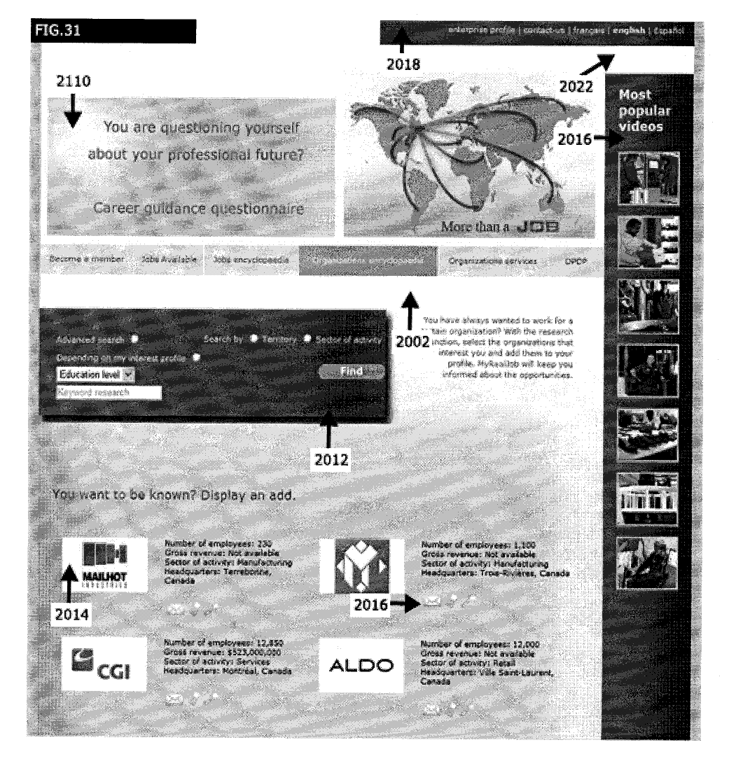

FIG. 31 is an exemplary screen display of a user interface depicting an example organization encyclopaedia page 2110 of the system 30 for a particular user. Organization encyclopaedia page 2110 includes a search window 2112 whereby the user may search for organizations by selecting certain criteria from a preset list, by keywords, and/or by company name. The organization encyclopaedia page 2110 may provide a featured-organizations area 2114 where the system may display a list of organizations that may be selected randomly by the system, or selected based on the organization's service package options, or based on the particular member's preferences. The featured-organizations area may further provide basic information about each of the listed organizations, such as the number of employees, gross revenue, location, industry area, or the like. The basic information may be provided by way of a loop of user-activated pictograms 2116, as previously described. The organization encyclopaedia page 2110 may also include a navigation panel 2002, a service panel 2018, a most popular video area 2016, and a member profile link 2022.

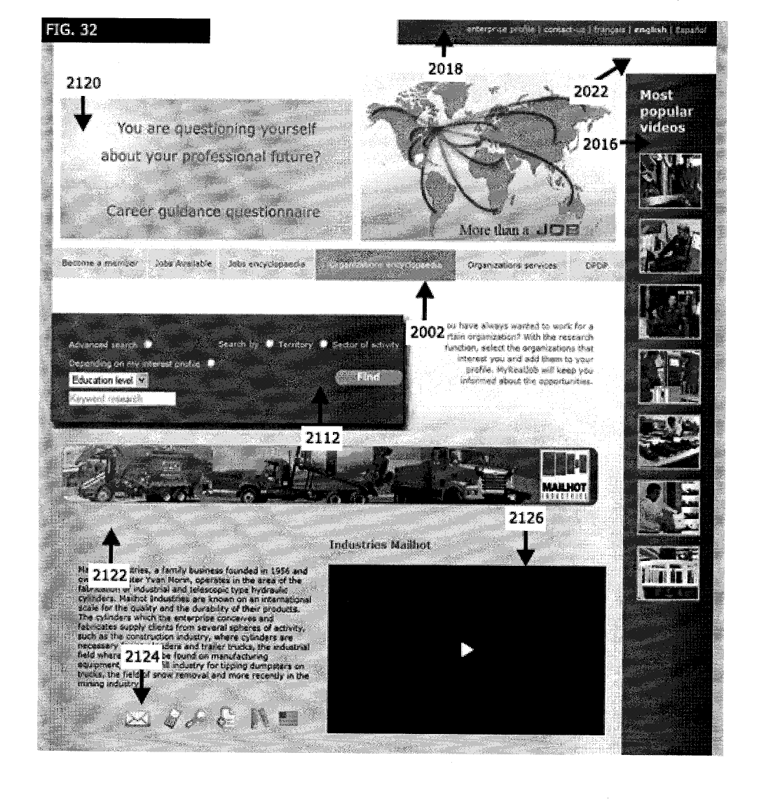

FIG. 32 is an exemplary screen display of a user interface depicting an example organization video page 2120 of a particular organization of the system 30 for a particular user. The organization video page 2120 includes a search window 2112, as described above, and an organization information area 2122. The organization information area 2122 may include a text description of the organization, a loop of user-activated pictograms 2124, a video viewing area 2126, and access to a mapping application, such as Google Street View Map™. As described above, the user may access different types of information about the organization by activating each pictogram or selecting (e.g. by a mouse click or by touch) each pictograms. The user view a video clip about the organization by selecting the video viewing area 2126. The organization video page 2120 may also include a navigation panel 2002, a service panel 2018, a most popular video area 2016, and a member profile link 2022.

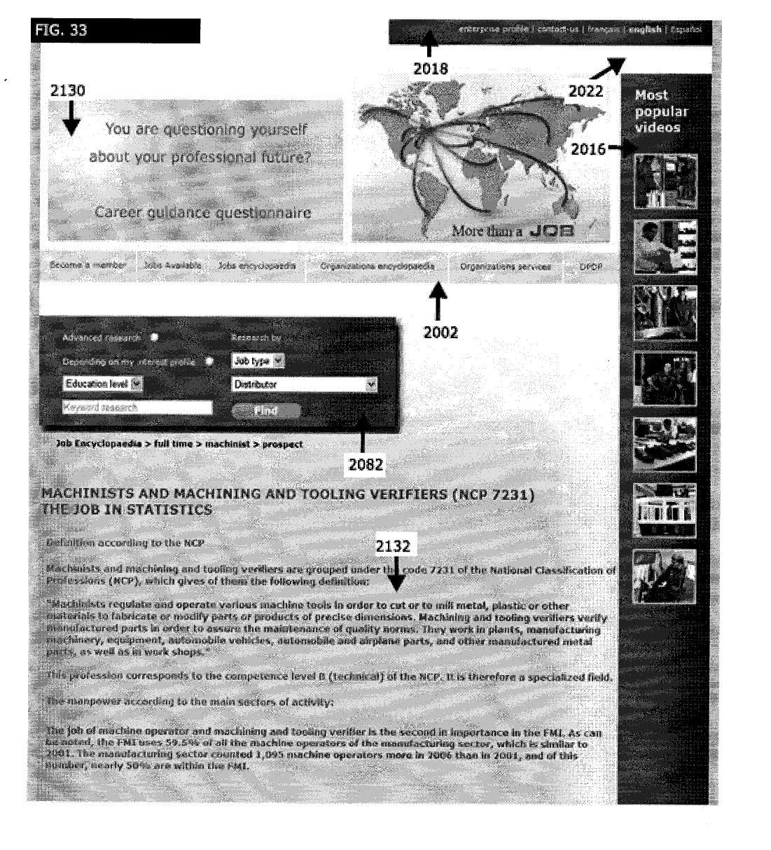

FIG. 33 is an exemplary screen display of a user interface depicting an example job statistical perspective page 2130 of the system 30 relating to a particular job for a particular user. The job statistical perspective page 2130 may be accessed via the corresponding link on the search results page 2090. The job statistical perspective page 2130 includes a search window 2082 and a job statistical perspective information area 2132, which provides information about the employment trends, and current and future demands for the particular job. The job statistical perspective page 2130 may also include a navigation panel 2002, a service panel 2018, a most popular video area 2016, and a member profile link 2022.

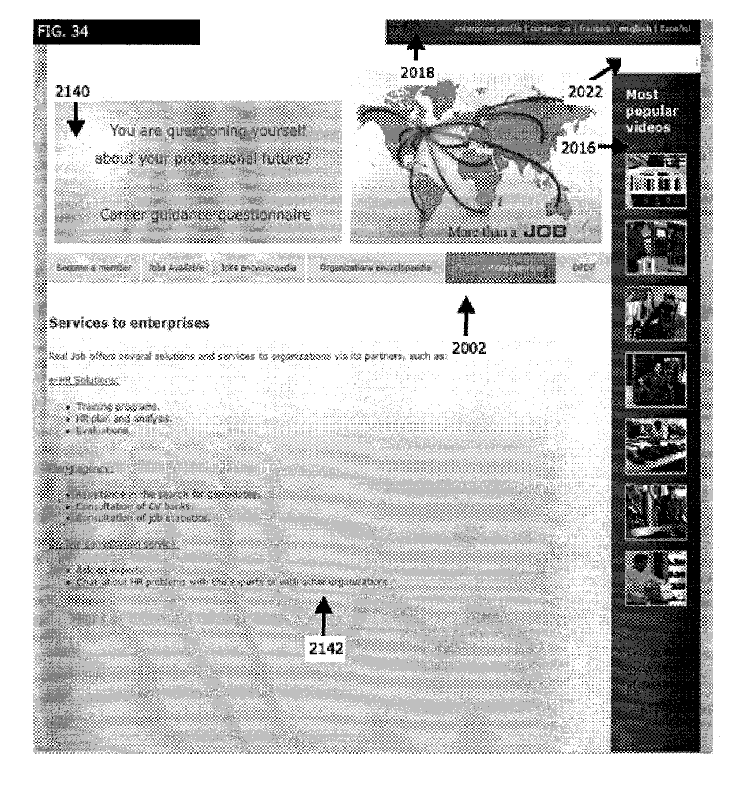

FIG. 34 is an exemplary screen display of a user interface depicting an example organization services page 2140 of the system 30 for a particular user. The organization services page 2140 includes a service listing area 2142, which provides information and links to various services, and some of the services may be provided by partners. The types of services that may be available to the user are described above in detail. The organization services page 2140 may also include a navigation panel 2002, a service panel 2018, a most popular video area 2016, and a member profile link 2022.

Although the invention has been described with reference to certain specific embodiments, various modifications thereof will be apparent to those skilled in the art without departing from the spirit and scope of the invention as outlined in the claims appended hereto.

We claim:

1. A computer system operation method for electronically screening a job applicant for an electronic job posting selected from a database of job postings, the method comprising the steps of:
retrieving a questionnaire associated with the electronic job posting from a database of questionnaires and displaying the questionnaire via a user interface associated with a computer, wherein the questionnaire comprises at least two polar questions, and wherein a preferred answer to each of the at least two polar questions, a weight associated with each preferred answer, and an eligibility threshold are preselected by a user other than the job applicant;
receiving answers to the at least two polar questions from the job applicant via the user interface;
determining an eligibility score using software, wherein the eligibility score is based on the number of answers the correspond to preferred answers and on the weight associated therewith;
comparing the eligibility score with the eligibility threshold using software; and
granting the job applicant access to an application process to the job via the user interface when the eligibility score exceeds the eligibility threshold.

2. The method of claim 1, wherein the weights of the preferred answers are adjustable by said user.

3. The method of claim 1, wherein the eligibility threshold is adjustable by said user.

4. The method of claim 1, further comprising the step of providing education information when the eligibility score is below the eligibility threshold.

5. A computer readable storage medium having stored thereon instructions for electronically screening job applicants for an electronic job posting selected from a database of job postings, such that when the instructions are executed by a computer, the instructions cause the computer to execute the steps comprising:
displaying on a user interface associated with the computer a questionnaire associated with the electronic job posting retrieved from a database of questionnaires, the questionnaire having at least two polar questions, wherein a preferred answer to each of the at least two polar questions, a weight associated with each preferred answer, and an eligibility threshold are preselected by a user other than the job applicant;
receiving answers to the at least two polar questions from the job applicant via the user interface;
determining an eligibility score based on the answers, wherein the eligibility score is based on the number of answers the correspond to preferred answers and on the weight associated therewith;
comparing the eligibility score with the eligibility threshold; and
granting the user access to an application process to the job via the user interface when the eligibility score exceeds the eligibility threshold.

6. The computer readable storage medium of claim 5, wherein the weights of the preferred answers are adjustable by said user.

7. The computer readable storage medium of claim 5, wherein the eligibility threshold is adjustable by said user.

8. The computer readable storage medium of claim 5, further comprising the step of providing the user with education information when the eligibility score is below the eligibility threshold.

9. A computer system operation method for facilitating online job searching, the method comprising the steps of:
receiving a job search request from a job applicant via a user interface associated with a computer, the job search request comprising at least one search criterion;
conducting a search of a first database having job entries stored therein, based on the at least one search criterion;
providing via the user interface a list comprising at least one job entry corresponding to the at least one search criterion, wherein each of the at least one job entry is represented by an illustrative image;
receiving a request to view one of the at least one job entry upon the job applicant's selection of the illustrative image associated with said one of the at least one job entry; and
retrieving a description associated with the job entry from a second database and presenting the description via the user interface, wherein the description is comprised of audio-visual data, and wherein, upon the job applicant's request, the description is one of a job description, an organization description and a geographical location description.

10. A computer readable storage medium having stored thereon instructions for facilitating online job searching, such that when the instructions are executed by a computer, the instructions cause the computer to execute a number of steps comprising:
receiving a job search request from a job applicant via a user interface associated with the computer, the job search request comprising at least one search criterion;
conducting a search of a first database having job entries stored therein, based on the at least one search criterion;
providing via a user interface a list comprising at least one electronic job entry corresponding to the at least one search criterion, wherein each of the at least one electronic job entry is represented by an illustrative image;
receiving a request to view one of the at least one electronic job entry upon the job applicant's selection of the illustrative image associated with said one of the at least one electronic job entry; and
retrieving a description associated with the electronic job entry from a second database and presenting the description via the user interface, wherein the description is comprised of audio-visual data, and wherein, upon the job applicant's request, the description relates to one of a job description, an organization description and a geographical location description.

11. The computer readable storage medium of claim 10, wherein the description further comprises a pictogram, wherein data associated with the pictogram retrieved from a third database and is presented via the user interface upon user activation of the pictogram.

12. The computer readable storage medium of claim 11, wherein the pictogram and the said data are previously linked to the electronic job entry by a user other than the job applicant.

13. A computer readable storage medium having stored thereon instructions for presenting a description of an electronic job posting, such that when the instructions are executed by a computer, the instructions cause the computer to execute the steps comprising:
displaying on a computer display at least two pictograms via a user interface, each of the at least two pictograms being capable of activation by a user, such that said activation cause retrieval and display by said computer of the said description about the electronic job posting; and
presenting the at least two pictograms via said user interface in a scrollable loop containing the said pictograms;
wherein the motion of the loop is controlled by user activation.

14. The computer readable storage medium of claim 13, wherein the loop is self-scrolling and the loop stops scrolling upon said activation thereof by the user.

15. The computer readable storage medium of claim 13, wherein the loop is put into a scrolling motion when activated by the user but is otherwise stationary when not so activated.

16. The computer readable storage medium of claim 13, wherein the said description is textual and is provided in a pop-up box associated with each pictogram when a selected pictogram is activated by the user.

17. The computer readable storage medium of claim 13, wherein a link is embedded in one of the at least two pictograms, and wherein when the one of the at least two pictograms is activated by the user, the said description is provided on a webpage associated with the link.

18. The computer readable storage medium of claim 13, wherein the said description comprises at least one of: organization contact information, integration strategy, social conventions, and immigration rules.

19. The computer readable storage medium of claim 17, wherein the webpage is an organization's webpage.

20. The computer readable storage medium of claim 13, wherein when one of the at least two pictograms is activated by the user, the one of the at least two pictograms provides the user access to a portal for submitting a question to an organization via the user interface.

21. The computer readable storage medium of claim 13, wherein each pictogram provides data about the job relating to one of: compensation structure and currency, pay raise policy, probation period, work experience and education requirements, working language, travel requirements, expense account policy, work schedule, work environment, allowable vacation days, employee benefits, technology requirements, overtime policy, parental leave policy, dress code, training program, pension plan, childcare facilities, parking policy, accessibility by public transit, publication date of the data, gross revenue of an organization associated with the job, size of the organization, culture of the organization, integration strategy for the organization, cultural and social customs of a geographical location of the organization, and legal and government procedural requirements for employment in the geographical location.
